(19) United States
(12) Patent Application Publication
(10) Pub. No.: US 2011/0236838 A1
(43) Pub. Date: Sep. 29, 2011

(54) COLOR PHOTOGRAPHIC MATERIALS WITH IMPROVED BLUE SENSITIZATION

(76) Inventors: David R. Foster, Rochester, NY (US); Drake M. Michno, Webster, NY (US)

(21) Appl. No.: 12/732,328

(22) Filed: Mar. 26, 2010

(51) Int. Cl. G03C 7/32; G03C 7/26

(52) U.S. Cl. 430/391; 430/559

(57) ABSTRACT

Color silver halide photographic elements having a yellow dye image-forming unit comprises at least one blue-sensitive silver iodobromide emulsion layer that has silver iodobromide grains. The silver iodobromide grains have initially associated therewith at least two blue spectral sensitizing dye layers comprising: (a) an inner dye layer adjacent the silver iodobromide grains comprising at least one anionic blue spectral sensitizing Dye 1, and (b) an outer dye layer adjacent to the inner dye layer comprising at least one cationic blue spectral sensitizing Dye 2. Dye 2 absorbs light at equal or higher energy than Dye 1. The maximum energy emission wavelength of Dye 2 overlaps but is not exactly corresponding to the maximum energy absorption wavelength of Dye 1. The silver iodobromide grains also have initially associated therewith an amine borane compound and a thiosulfonate compound.

### FIELD OF THE INVENTION

This invention relates to color photographic elements that contain specifically treated blue-sensitive silver halide emulsion layers to provide improved chemical and spectral sensitization. This invention also relates to a method of providing color images using these photographic elements and to methods of providing the improved color photographic elements that are particularly useful as motion picture films.

### BACKGROUND OF THE INVENTION

For more than a century, it has been known that certain silver halide materials are sensitive to actinic radiation and, upon exposure to such radiation, form latent images capable of being subsequently developed using an appropriate processing solution into a visible image. Silver halide materials have provided superior performance in various uses over other radiation sensitive materials, including their use as color motion picture films including originating color motion picture films, intermediate films, and color print films.

In order to steadily increase the sensitization of silver halide grains used in silver halide materials, photographic chemists have varied the methods of making the silver halide grains and emulsions in which they are incorporated into color photographic elements, and have used various “sensitizing” compounds in these methods. Typically, such silver halide emulsions have been prepared by forming a dispersion of microcrystals (grains) of silver halide in a solution of protective colloid (such as gelatin), increasing the grains to desired size (ripening), washing or coagulating the grains to remove undesired components, and adding spectral sensitizers, chemical sensitizers, or both in appropriate order.

Photographic chemists have also added various heteroatom-containing compounds to silver halide emulsions to increase sensitivity, stability, or image contrast as described for example in U.S. Pat. Nos. 5,399,479 (Lok) and 5,411,855 (MacIntyre et al.). For example, amine boranes can also be present in the predominantly silver chloride emulsions.

J-aggregating cyanine dyes are used in many photographic materials. It is believed that these dyes adsorb to the grains of a silver halide emulsion and pack together on their “edge” to allow the maximum number of dye molecules to be placed on the grain surfaces. However, a monolayer of dye molecules, even one with a high extinction coefficient such as a J-aggregated cyanine dye, absorbs only a small fraction of the light impinging on it per unit area. The use of tabular silver halide grains allows even more dye molecules to be put onto each unit or area, and thus per mole of silver. However, not all available light is captured even on tabular grains.

The need to enhance spectral-specific light capture is especially great in the blue spectral region where a combination of low source intensity and relatively low dye extinction results in a deficient photo response. One way to increase this sensitivity is to increase the amount of blue spectral sensitizing dyes to create a greater than monolayer presence of the dyes. Other approaches have increased sensitivity by modifying the dye molecules to provide two or more chromophores in each dye molecule connected by linking groups but the chromophores may interfere with each other by reducing aggregation or silver halide grain absorption. Polymers with multiple pendant chromophores have also been prepared and used for this purpose.

It is also known to add multiple cyanine dyes to silver halide emulsion formulations in a sequential fashion to reduce dye desensitization, but this approach is usually inadequate as there is insufficient adsorption of dye to the silver halide grains. Still other approaches are directed to the use of two or more cyanine dyes to form layers on the silver halide grains (“dye layering”) wherein the outer dye layer absorbs light at a shorter wavelength than the inner dye layer.

This dye layering approach is described in U.S. Pat. No. 6,699,652 (Johnston et al.) in which the described color photographic materials also contain certain pyrazolotriazole color dye forming couplers. The use of J-aggregated cyanine dyes of opposite charge is described in U.S. Pat. No. 6,329,133 (Andrievsky et al.).

In order to improve illuminant insensitivity for color negative films, an additional blue dye that sensitizes near the 435 nm mercury emission line that is added to the blue spectrally-sensitized components is preferred. However, substituting part of the long wavelength blue spectral sensitizing dye with a shorter wavelength blue spectral sensitizing dye results in speed loss because of the decrease in integrated light absorption with tungsten and daylight illumination. This blue speed deficiency can have costly color reproduction impact, particularly in high speed color films. In addition, current color film structures do not fully utilize all of the light that strikes the color film. Absorbing more blue light per mole of silver would allow higher speed with no increase in granularity, or alternatively, it would provide improved granularity at equal speed by using smaller grains. An equally viable option is to capitalize on the improved light absorption by reducing the amount of silver halide deployed in the blue record, resulting in improved optical quality of the image transmitted to the underlying red and green records as well as reduced radiation sensitive (U.S. Pat. No. 6,699,652B1, Johnston et al.). Using shorter wavelength blue spectral sensitizing dye layering allows for illuminant insensitivity improvement without loss of blue film speed.

In addition, current color negative emulsions are not fully efficient at forming latent images because of electron-hole recombination losses. Introducing reduction sensitization in combination with sulfur and gold chemical sensitization has the potential to eliminate photo-holes and reduce recombination losses. Reduction sensitization would allow higher speed with no increase in granularity or, alternatively, improved granularity at equal speed by using smaller grains. There is a pressing need for higher speed with no grain penalty in grain sensitive products such as consumer or motion picture high-speed films. This need is particularly needed for tungsten-balanced films, particularly where the films contain larger silver halide grains at high coating laydown to capture as much of the blue light emitted by the tungsten light source as possible.

### SUMMARY OF THE INVENTION

The present invention provides a color silver halide photographic element comprising a support having thereon:

a yellow dye image-forming unit comprising at least one blue-sensitive silver iodobromide emulsion layer having associated therewith at least one yellow dye-forming coupler,

wherein the at least one blue-sensitive silver iodobromide emulsion layer comprises silver iodobromide grains having an aspect ratio of from about 2 to about 40 and comprising at least 1 and up to and including 15 mol % iodide, which silver iodobromide grains have associated therewith at least two blue spectral sensitizing dye layers comprising:

(a) an inner dye layer adjacent the silver iodobromide grains comprising at least one anionic blue spectral sensitizing Dye 1, and

(b) an outer dye layer adjacent to the inner dye layer comprising at least one cationic blue spectral sensitizing Dye 2,

wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,

wherein the silver iodobromide grains also have initially associated therewith an amine borane compound in an amount of from about 0.03 to about 0.5 μmol per mol of silver iodobromide, and

wherein the silver iodobromide grains also have initially associated therewith from about 0.8 to about 4 μmol per mol of silver iodobromide of a thiosulfonate compound having the structure:

R¹—SO₂S-M¹

wherein R¹ represents an aliphatic, carbocyclic, or heterocyclic group and M¹ represents a mono-, di-, or tri-valent cation.

In addition, the present invention provides a color silver halide photographic element comprising a support having thereon:

a cyan dye image-forming unit comprising at least one red-sensitive silver halide emulsion layer having associated therewith at least one cyan dye-forming coupler,

a magenta dye image-forming unit comprising at least one green-sensitive silver halide emulsion layer having associated therewith at least one magenta dye-forming coupler, and

a yellow dye image-forming unit comprising at least one blue-sensitive silver iodobromide emulsion layer having associated therewith at least one yellow dye-forming coupler,

wherein the at least one blue-sensitive silver iodobromide emulsion layer comprises silver iodobromide grains having an aspect ratio of from about 2 to about 40 and comprising at least 1 and up to and including 15 mol % iodide, which silver iodobromide grains have associated therewith at least two blue spectral sensitizing dye layers comprising:

(a) an inner dye layer adjacent the silver iodobromide grains comprising at least one anionic blue spectral sensitizing Dye 1, and

(b) an outer dye layer adjacent to the inner dye layer comprising at least one cationic blue spectral sensitizing Dye 2,

wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,

wherein the silver iodobromide grains also have initially associated therewith an amine borane compound in an amount of from about 0.03 to about 0.5 μmol per mol of silver iodobromide, and

wherein the silver iodobromide grains also have initially associated therewith from about 0.8 to about 4 μmol per mol of silver iodobromide of a thiosulfonate compound having the structure:

R¹—SO₂S-M¹

wherein R¹ represents an aliphatic, carbocyclic, or heterocyclic group and M¹ represents a mono-, di-, or tri-valent cation.

Some embodiments of the present invention are motion picture originating films (that is, multicolor motion picture originating films).

This invention also provides a method of providing a color photographic image comprising color developing the photographic element of this invention that has been imagewise exposed, using a color developing agent.

Further, a method of making the photographic element of this invention comprises:

preparing a blue-sensitive silver iodobromide emulsion by mixing silver iodobromide grains having an aspect ratio of from about 2 to about 40 and comprising at least 1 and up to and including 15 mol % iodide, individually with:

(a) an anionic blue spectral sensitizing Dye 1 to provide an inner dye layer adjacent the silver iodobromide grains,

(b) a cationic blue spectral sensitizing Dye 2 to provide an outer dye layer adjacent to the inner dye layer,

wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,

(c) an amine borane compound in an amount of from about 0.03 to about 0.5 μmol per mol of silver iodobromide, and

(d) from about 0.8 to about 4 μmol per mol of silver iodobromide of a thiosulfonate compound having the structure:

R¹—SO₂S-M¹

wherein R¹ represents an aliphatic, carbocyclic, or heterocyclic group and M¹ represents a mono-, di-, or tri-valent cation, and

applying the blue-sensitive silver halide emulsion to a support.

Some embodiments of this invention include a method of preparing a blue-sensitive silver iodobromide emulsion by mixing silver iodobromide grains having an aspect ratio of from about 2 to about 40 and comprising at least 1 and up to and including 15 mol % iodide, individually with:

(a) an anionic blue spectral sensitizing Dye 1 to provide an inner dye layer adjacent the silver iodobromide grains,

(b) a cationic blue spectral sensitizing Dye 2 to provide an outer dye layer adjacent to the inner dye layer,

wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,

(c) an amine borane compound in an amount of from about 0.03 to about 0.5 μmol per mol of silver iodobromide, and

(d) from about 0.8 to about 4 μmol per mol of silver iodobromide of a thiosulfonate compound having the structure:

R¹—SO₂S-M¹

wherein R¹ represents an aliphatic, carbocyclic, or heterocyclic group and M¹ represents a mono-, di-, or tri-valent cation,

wherein the blue-sensitive silver iodobromide emulsion is prepared using the following sequence of steps:

(a′) mixing the silver iodobromide grains with the amine borane compound,

(b′) mixing the silver iodobromide grains with a first portion of a thiosulfonate compound,

(c′) mixing the silver iodobromide grains with the Dye 1,

(d′) mixing the silver iodobromide grains with a second portion of a thiosulfonate compound,

(e′) chemically sensitizing the silver iodobromide grains with sulfur, gold, or both sulfur and gold,

(f′) treating the silver iodobromide grains by: heating them to a temperature of from about 50 to about 70° C., holding the silver iodobromide grains at the temperature for at least 3 and up to and including 60 minutes, and cooling the silver iodobromide grains to a temperature of from about 35 to about 45° C., and

(g′) mixing the silver iodobromide grains with the Dye 2.

For example, in this method, the second portion of the thiosulfonate compound can be the same as or less than the first portion of the thiosulfonate compound.

The present invention thus provides blue-sensitive silver halide emulsions for use in various color image capture films with improved blue light sensitivity, as well as reduced “noise” from reduced granularity because smaller tabular silver halide grains can be used. These advantages are achieved by the use of a combination of anionic and cationic cyanine blue light spectral sensitizing dyes, and a method for enhancing latent image formation and preservation employing a combination of a reducing agent based on amino borohydride in concert with a “controlling” thiosulfonate oxidant.

The additive impact of the combination of blue spectral sensitizing dye layering and reduction sensitization according to this invention results in significantly higher blue speed than by using either sensitization alone. The higher blue speed enables the full exploitation of the above mentioned benefits for color negative films. The present invention is particularly useful to provide tungsten-light sensitive color image capture photographic elements such as color negative films and color motion picture originating films.

### DETAILED DESCRIPTION OF THE INVENTION

### Definitions

Unless otherwise indicated, the terms “element” or “film” refer to the color silver halide photographic elements of this invention. Such elements can also be known as “color photographic films”, “color film”, “silver halide films”, and “color photographic element”.

As used herein, the terms “inner dye layer” and “outer dye layer” individually refer to one or more layers of spectral sensitizing dyes of the same class. That is, multiple inner dye layers contain the same or different Dye 1 molecules and multiple outer dye layers contain the same or different Dye 2 molecules.

When the term “initially associated therewith” is used herein, it signifies that a compound is in or adjacent to a specified layer or specific compound or component, and the indicated amount is the initial amount of compound or component that is added to the mixture.

When used in this application in defining the dyes, amino borane compounds, thiosulfonate compounds, the term “group” is used to refer to a moiety or radical that may itself be unsubstituted or substituted with one or more substituents (up to the maximum possible number). For example, “alkyl group” refers to a substituted or unsubstituted alkyl, while “benzene group” refers to substituted or unsubstituted benzene (with up to six substituents). Generally, unless otherwise specifically stated, substituent groups usable on molecules herein include any groups, whether substituted or unsubstituted, which do not destroy properties necessary for the photographic utility. Examples of substituents on any of the mentioned groups can include known substituents, including but not limited to, halogen (for example, chloro, fluoro, bromo, and iodo), alkoxy, particularly those “lower alkyl” (that is, with 1 to 6 carbon atoms, for example, methoxy, and ethoxy), substituted or unsubstituted alkyl, particularly lower alkyl (for example, methyl and trifluoromethyl), thioalkyl (for example, methylthio and ethylthio), particularly either of those with 1 to 6 carbon atoms, substituted and unsubstituted aryl, particularly those having from 6 to 20 carbon atoms (for example, phenyl), and substituted or unsubstituted heteroaryl, particularly those having a 5 or 6-membered ring containing 1 to 3 heteroatoms selected from N, O, or S (for example, pyridyl, thienyl, furyl, and pyrrolyl), acid or acid salt groups such as any of those described below; and others known in the art. Alkyl substituents may specifically include “lower alkyl” (that is, having 1-6 carbon atoms), for example, methyl, ethyl, and isopropyl. Further, with regard to any alkyl group or alkylene group, it will be understood that these can be branched or unbranched and include ring structures.

### Blue Light Spectral Sensitizing Dyes

In the elements of this invention, at least one blue-sensitive silver iodobromide emulsion layer contains silver iodobromide grains that have associated therewith at least two blue spectral sensitizing dyes that form two dye layers on the grains. The inner dye layer that is closer to (adjacent) the silver iodobromide grains, comprises one or more anionic spectral sensitizing dyes that are identified herein in the Dye 1 class of dyes. The outer dye layer is adjacent to the inner dye layer comprises one or more cationic blue sensitizing dyes that are identified herein in the Dye 2 class of dyes.

Dye 1 and Dye 2 in the inner and outer dye layers are held together by substantially only non-covalent attractive forces such as electrostatic attraction, hydrophobic interactions, hydrogen bonding, van der Waals interactions, dipole-dipole interactions, dipole-induced dipole interactions, London dispersion forces, cation-π interactions, or any combination of these forces such as a combination of hydrogen bonding with one of the other non-covalent forces.

Some of the Dye 1 and Dye 2 molecules are substituted with at least one hydrogen bonding donor substituent to enhance hydrogen bonding as one of the non-covalent forces that attract the two dye layers. The atom to which a hydrogen atom is more tightly linked in called the hydrogen bonding donor whereas the other atom sharing the hydrogen atom is considered the hydrogen bonding acceptor. The hydrogen bonding acceptor has a partial negative charge that attracts the hydrogen atom. The bond energies range from 2 to 9 kcal/mol. Consequently, these provide for a substantial binding strength between the inner and outer dye layers. Hydrogen bonds are particularly strong between oxoanions such as carboxylates, sulfonates, sulfinates, phosphates, and phosphonates and unsubstituted or substituted ammonium, amidinium, and guanidinium cations or various imines of urea as described in F. Schmidtchen, Tetrahedron Lett. 30, 4493 (1989) and M. D. Ward et al., J. Am. Chem. Soc. 116, 1941 (1994). This is because a combination of electrostatic attractions with hydrogen bonding results in higher overall binding strength.

Therefore, in some embodiments, a silver halide color photographic material has silver iodobromide grains in a blue-sensitive silver iodobromide emulsion layer that have associated therewith a combination of Dye 1 and Dye 2 dyes, wherein at least one Dye 2 contains at least one guanidinium or amidinium substituent. In other embodiments, the silver iodobromide grains having associated therewith a Dye 2 that contains at least one primary, secondary or tertiary ammonium substituent. Ammonium group means protonated amino group such as alkylammonium or arylammonium groups as well as ammonium groups containing heterocyclic functional groups. Ammonium groups here also encompass groups in which nitrogen atom is attached to another nitrogen atom, to oxygen atom, or to sulfur atom, for example, salts of diazanes, triazanes, diazenes, triazenes, azanols (hydroxylamines), azanethiols, or oximes. Other examples can include imino-groups, such as cyanoimino, hydroxyimino, mercaptoimino, hydrazo, hydrazono, azo, or azino groups. It is understood, that a hydrogen bonding donor and positive charge are not necessarily located on the same substituent.

The positive charge on Dye 2 molecules can be formed in situ in the emulsion by protonation. This is possible when the molecule has a substituent with a pKa value of a conjugate acid that is equal to or higher than 5. Typical pKa values are well known, and are tabulated in, e.g., J. A. Dean Lange's Handbook of Chemistry, 13th edition, Mc-Graw Hill, N.Y., 1985 and D. D. Perrin Dissociation Constants of Organic Bases in Aqueous Solution, Butterworths, London, 1965.

It is desired that the Dye 1 dyes used in the inner dye layer form a J-aggregate. For a discussion of J-aggregation see The Theory of the Photographic Process, 4th edition, T. H. James, editor, Macmillan Publishing Co., New York, 1977). The Dye 2 dyes present in the outer dye layer can also form a J-aggregation. The aggregation properties of a dye can be determined by coating the dye on silver halide grains. The wavelength of maximum light absorbance and sensitization of the dye can be determined from the coatings by spectroscopic analysis.

The outer dye layer containing Dye 2 absorbs light at an equal or higher energy (equal or shorter wavelength) than the adjacent inner dye layer containing Dye 1. The maximum energy emission wavelength of the outer dye layer (containing Dye 2) overlaps but is not exactly corresponding with the maximum energy absorption wavelength of the adjacent inner dye layer (containing Dye 1). Dye 1 generally has a maximum energy absorption wavelength of from about 450 to about 490 nm, and Dye 2 generally has a maximum energy absorption wavelength of from about 400 to about 460 nm.

Dye 1 may be, for example, a cyanine dye, complex cyanine dye, homopolar cyanine dye, hemicyanine dye, merocyanine dye, arylidene dye, complex merocyanine dye, styryl dye, hemioxonol dye, oxonol dye, anthraquinone dye, triphenylmethane dye, azo dye type, azomethine dye, or a coumarin dye. Dye 1 comprises at least one anionic substituent. Examples of anionic substituents are alkyl groups containing acid salts such as salts of sulfonic acids, sulfato groups, salts of phosphonic acids, salts of carboxylic acids, and salts of nitrogen acids, such as imides, N-acylsulfonamides, and N-sulfonylsulfonamides. Useful acid salt substituents are salts of sulfonic acids, carboxylic acids, and nitrogen acids. The alkyl groups bearing the acid salt substituent may be further substituted. Some specific examples of alkyl groups with acid salt substituents include but are not limited to, 2-sulfoethyl, 3-sulfopropyl, 3-sulfobutyl, 4-sulfobutyl, 3-sulfo-2-hydroxypropyl, sulfoethylcarbamoylmethyl, 2-carboxyethyl, 3-carboxypropyl, 2-sulfo-2-carboxyethyl, and methanesulfonylcarbamoylmethyl.

Dye 2 is not necessarily a spectral sensitizing dye, but such dyes may be, for example, a cyanine dye, complex cyanine dye, homopolar cyanine dye, hemicyanine dye, merocyanine dye, complex merocyanine dye, arylidene dye, complex merocyanine dye, styryl dye, hemioxonol dye, oxonol dye, anthraquinone dye, triphenylmethane dye, azo dye type, azomethine dye, or a coumarin dye. Dye 2 has at least one cationic substituent that can be a substituent that can be protonated to become a cationic substituent. Examples of positively charged substituents are 3-(trimethylammonio)propyl), 3-(4-ammoniobutyl), and 3-(4-guanidinobutyl). Other examples are any substituents that take on a positive charge in the silver halide emulsion melt, for example, by protonation such as aminoalkyl substituents, for example, 3-(3-aminopropyl), 3-(3-dimethylaminopropyl), and 4-(4-methylaminopropyl).

More particularly, Dye 1 can be a cyanine dye represented by the following Structure (Ia) or a merocyanine represented by Structure (Ib):

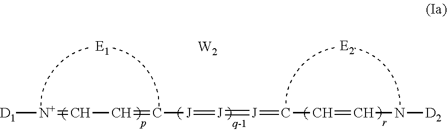

wherein E₁ and E₂ may be the same or different and represent the atoms necessary to form a substituted or unsubstituted heterocyclic ring that is a basic nucleus (see The Theory of the Photographic Process, 4th edition, T. H. James, editor, Macmillan Publishing Co., New York, 1977 for a definition of basic and acidic nucleus), each J independently represents a substituted or unsubstituted methine group, q is a positive integer of from 1 to 4, p and r each independently represents 0 or 1, D₁ and D₂ each independently represents substituted or unsubstituted alkyl or substituted or unsubstituted aryl, wherein at least one of D₁ and D₂ contains an anionic substituent, and at least one of D₁ and D₂ contains a hydrogen bond accepting substituent, and W₂ is one or more counterions as necessary to balance the charge;

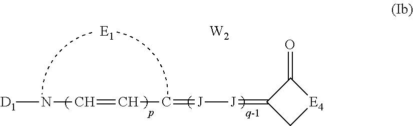

wherein E₁, D₁, J, p, q, and W₂ are as defined above for Structure (Ia), E₄ represents the atoms necessary to complete a substituted or unsubstituted heterocyclic acidic nucleus that optionally contains a thiocarbonyl group.

More particularly, Dye 2 can be represented by any of the following Structures (IIa), (IIb), and (IIc):

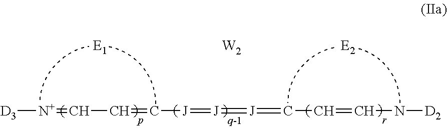

wherein E₁, E₂, J, p, q, and W₂ are as defined above for Structure (Ia), D₃ and D₄ each independently represents a substituted or unsubstituted alkyl or substituted or unsubstituted aryl group, and at least one of E₁, E₂, J, or D₃ and D₄ contains a cationic substituent and at least one of E₁, E₂, J, or D₃ and D₄ contains a hydrogen bond donating substituent;

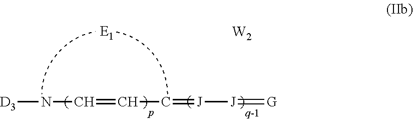

wherein E₁, D₃, J, p, q, and W₂ are as defined above for Structure (Ia) and G represents

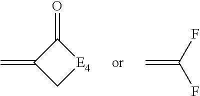

wherein E₄ represents the atoms necessary to complete a substituted or unsubstituted heterocyclic acidic nucleus, and F and F′ each independently represents a cyano, ester, acyl, carbamoyl, or alkylsulfonyl group, and at least one of E₁, G, J, or D₃ contains a cationic substituent and at least one of E₁, G, J, or D₃ contains a hydrogen bond donating substituent;

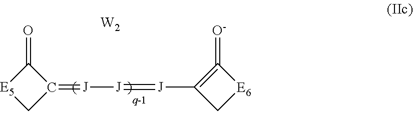

wherein J and W₂ are as defined above for Structure (Ia), q is 2, 3, or 4, and E₅ and E₆ independently represent the atoms necessary to complete a substituted or unsubstituted acidic heterocyclic nucleus and at least one of J, E₅, or E₆ contains a cationic substituent and at least one of J, E₅, or E₆ contains a hydrogen bond donating substituent.

As noted above, at least one Dye 1 in the inner dye layer has a net negative (anionic) charge and at least one Dye 2 in the outer dye layer has a net positive (cationic) charge. In some embodiments where Dye 1 and Dye 2 are both cyanine dyes, the anionic and cationic dyes do not both have an aromatic or heteroaromatic group attached to the dye by means of the nitrogen atom of the cyanine chromophore.

Further details of useful dyes for Dye 1 and Dye 2 are provided in Columns 9-24 of U.S. Pat. No. 6,329,133 (noted above) that is incorporated herein by reference for this purpose. Included in these details are methods of making these dyes (Columns 11-12) and specific useful dyes in TABLE I. Specific dyes are described in TABLE I of the noted U.S. Pat. No. 6,328,133 including Dyes I-1 through I-3 and II-1 through II-37. Dye II-15 is particularly useful. Other useful dyes are described in the references cited in Columns 6 and 7 of U.S. Pat. No. 6,699,652 (noted above) that is incorporated by reference for this purpose.

The amount of Dye 1 that is useful in the invention is generally from about 0.4 to about 0.9 mmol, or from 0.75 to 0.85 mmol, per mol of silver iodobromide in the inner dye layer. The amount of Dye 2 that is useful in the invention is generally from about 0.7 to about 1.6 mmol, or from 0.8 to 1.2 mmol, per mol of silver iodobromide in the outer dye layer. Optimum dye concentrations can be determined for each dye layer using routine experimentation and methods known in the art.

The silver iodobromide grains described herein may be sensitized by Dye 1 by any method known in the art, such as described in Research Disclosure, September 1996, Number 389, Item 38957, which will be identified hereafter by the term “Research Disclosure I.” The dye may, for example, be added as a solution or dispersion in water, alcohol, aqueous gelatin, alcoholic aqueous gelatin, or microcrystalline dispersion. Several dyes may be added simultaneously from a common solution or dispersion. The silver iodobromide emulsion may be mixed with a dispersion of a color image-forming coupler immediately before coating or in advance of coating. Dye 2 is added to the silver iodobromide grains that are sensitized with Dye 1 by at an appropriate time as described below. Generally, Dye 2 is added after the thiosulfate, amine borane and Dye 1 have been added in suitable amounts.

### Thiosulfonate Compounds

The blue-sensitive silver iodobromide emulsion layer(s) described herein contain one or more thiosulfonate compounds so that the thiosulfonate compound(s) is associated with the silver iodobromide grains. The thiosulfonate compounds can be represented by the following Structure (III):

R¹—SO₂S-M¹ (III)

wherein R¹ represents an aliphatic, carbocyclic (including aryl), or heterocylic group and M¹ represents a mono-, di-, or tri-valent cation.

Examples of useful aliphatic groups include but are not limited to, alkyl groups having 1 to 22 carbon atoms (such as methyl, hydroxymethyl, ethyl, isopropyl, n-pentyl, t-butyl, hexyl, octyl, ethylhexyl, decyl, dodecyl, hexadecyl, and unadecyl groups), alkenyl groups having 2 to 22 carbon atoms (such as ethenyl, butenyl, and isomers of other alkenyl groups), and alkynyl groups having 2 to 22 carbon atoms (such ethynyl, butynyl, and isomers of other alknyl groups). Examples of useful carbocyclic groups include substituted or unsubstituted cycloalkyl and cycloalkenyl groups having 5 to 20 carbon atoms in the ring (such as cyclopentyl, cyclohexyl, cyclohexenyl, cycloheptatrienyl, cyclooctatrienyl, and cyclononatrienyl groups) and substituted or unsubstituted aryl groups having 6 or 20 carbon atoms in the rings (such as phenyl, naphthyl, tolyl, and 4-methylphenyl groups). Useful heterocyclic groups comprise 3 to 15 carbon, nitrogen, oxygen, selenium, tellurium, or sulfur atoms in the heteroring (such as pyrrole, furan, tetrahydrofuran, pyridine, picoline, piperidine, morpholine, pyrrolidone, thiophene, oxazole, thiazole, imidazole, selenazole, tellurazole, triazole, tetrazole, and oxadiazole groups).

R¹ can be substituted with one or more alkyl groups (such as methyl, ethyl t-butyl, and hexyl), fluoroalkyl groups (such as trifluoromethyl), halogen atoms, alkoxy groups (such as methoxy, ethoxy, benzoxy, and octyloxy), aryloxy groups (such as phenoxy), alkylthio groups (such as methylthio and n-propylthio), aryl groups (such as phenyl, napthyl, and tolyl), arylthio groups (such as phenylthio), acyl groups (such as acetyl, propionyl, and valeryl), sulfonyl groups (such as methylsulfonyl and phenylsulfonyl), acylamino groups, sulfonylamino groups, acyloxy groups (such as acetoxy and benzoxy), carboxy, cyano, sulfo, hydroxyl, and amino groups.

R¹ may also be substituted with one or more divalent linking group that include an atom or group containing at least one carbon, nitrogen, sulfur, or oxygen atom. Such linking groups can include but are not limited to, alkylene, alkenylene, alkynylene, arylene, oxy, thio, amino, carbonyl, and sulfonyl groups. When such as linking group is present, the thiosulfonate can be an oligomer or polymer with the repeating units being derived from Structure (I) and the linking group.

M¹ can be a mono-, di-, or tri-valent metal ion such as alkali metal ions (for example, lithium, sodium, and potassium ions), alkaline earth metal ions (such as calcium ions), ammonium ions, sulfonium ions, and phosphonium ions. A useful thiosulfate is potassium p-toluenethiosulfonate.

Upon reaction of the thiosulfonate compounds with the silver atom clusters, these compounds are converted to silver sulfide and sulfinate compounds to the extent of their reaction. Thus, the finished silver iodobromide emulsion will likely contain both thiosulfonate and sulfinate compounds. In most instances, most of the thiosulfonate molecules will be converted to sulfinate molecules. Such sulfinate compounds can be represented by the following Structure (IV):

R²—SO₂-M² (IV)

wherein R² represents an aliphatic, carbocyclic, or heterocyclic group as defined above for R¹ and M² represents a mono-, di-, or tri-valent cation. M² is defined in the same manner as M¹. One sulfinate is sodium p-toluenesulfinate.

The thiosulfonate compounds useful in this invention can be obtained from a number of commercial sources that supply chemical compounds.

The thiosulfonate is initially present, or added in one or more portions, in an amount of from about 0.8 to about 4 μmol per mol of silver iodobromide, or from about 1 to about 2.5 mmol per mol of silver iodobromide, in the blue-sensitive silver iodobromide emulsion layer. As noted below, the thiosulfonate can be added to the silver iodobromide grains and emulsion in at least two portions, and generally in only two portions, in which the first portion is at as large as or larger than the second portion. In other words, the weight ratio of the first to second portions of thiosulfonate added to the silver iodobromide emulsion can be from about 2:1 to about 1:2, or typically from 1:1 to 2:1. The thiosulfonates used in each portion can be the same or different and in most embodiments, they are the same compound.

The optimum amount of thiosulfonate, whether used in one or multiple portions, can be determined by a skilled artisan using routine experimentation and the teaching provided in this application.

### Amine Borane Compounds

The useful amine borane compounds can be generally defined by the following Structure (V):

(R³)(R⁴)(R⁵)N—BH₃⁺ (V)

wherein R³, R⁴, and R⁵ independently represent hydrogen atoms or aliphatic, carbocyclic (including aryl), or heterocyclic groups, which may be substituted or unsubstituted. Examples of useful aliphatic groups include but are not limited to, alkyl groups having 1 to 22 carbon atoms (such as methyl, hydroxymethyl, ethyl, isopropyl, n-pentyl, t-butyl, hexyl, octyl, ethylhexyl, decyl, dodecyl, hexadecyl, and unadecyl groups), alkenyl groups having 2 to 22 carbon atoms (such as ethenyl, butenyl, and isomers of other alkenyl groups), and alkynyl groups having 2 to 22 carbon atoms (such ethynyl, butynyl, and isomers of other alknyl groups). Examples of useful carbocyclic groups include substituted or unsubstituted cycloalkyl and cycloalkenyl groups having 5 to 20 carbon atoms in the ring (such as cyclopentyl, cyclohexyl, cyclohexenyl, cycloheptatrienyl, cyclooctatrienyl, and cyclononatrienyl groups) and substituted or unsubstituted aryl groups having 6 or 10 carbon atoms in the rings (such as phenyl, naphthyl, tolyl, and 4-methylphenyl groups). Useful heterocyclic groups comprise 3 to 20 carbon, nitrogen, oxygen, selenium, tellurium, or sulfur atoms in the heteroring (such as pyrrole, furan, tetrahydrofuran, pyridine, picoline, piperidine, morpholine, pyrrolidone, thiophene, oxazole, thiazole, imidazole, selenazole, tellurazole, triazole, tetrazole, and oxadiazole groups). R³, R⁴, and R⁵ can be substituted as described above for R¹.

In some embodiments, R³ is an alkyl or hydroxyalkyl group having 1 to 20 carbon atoms, and R⁴ and R⁵ are independently hydrogen atoms or alkyl or hydroxyalkyl groups having 1 to 20 carbon atoms.

Specific amine borane compounds useful in the practice of this invention include but are not limited to, trimethylamine borane, t-butylamine borane, dimethyl dodecylamine borane, ethanolamine borane, diethanolamine borane, pyridine borane, picoline borane, and other substituted or unsubstituted alkylamine boranes and heterocyclic boranes.

Useful amine borane compounds can be obtained from various commercial sources of chemical compounds.

One or more amine borane compounds are generally initially present with the silver iodobromide grains in an amount of from about 0.03 to about 0.5 μmol per mol of silver iodobromide, or typically from 0.06 to 0.2 μmol per mol of silver iodobromide in the blue-sensitive silver iodobromide emulsion layer into which they are incorporated. The optimal amount of amine borane compound can be determined for a given combination of Dye 1 and Dye 2 by a skilled artisan using routine experimentation and the teaching provided in this application.

It is also useful to adjust the amount of amine borane compound and thiosulfonate compound that are initially added to the emulsion in relationship to each other. For example, the amine borane compound (or mixture thereof) and one or more thiosulfonate compounds initially associated with the silver iodobromide grains can be used in a molar ratio of from about 0.04:1 to about 0.12:1 (amine borane to thiosulfonate).

The amine borane compounds can be incorporated into the blue-sensitive silver iodobromide emulsion layer(s) at any suitable time during the preparation of the emulsion or photographic element, but specific useful times for introducing the compounds are described below. In general, these compounds are mixed with silver iodobromide grains before the addition of Dye 1, thiosulfonate compound, and Dye 2.

### Color Photographic Element Construction

The photographic elements are single-color elements having a blue-sensitive silver iodobromide emulsion layer, or multi-color elements that contain image dye-forming units sensitive to each of the three primary regions of the spectrum. Each unit can comprise a single emulsion layer or multiple emulsion layers sensitive to a given region of the spectrum. The layers of the element, including the layers of the image-forming units, can be arranged in various orders as known in the art. In an alternative format, the emulsions sensitive to each of the three primary regions of the spectrum can be disposed as a single segmented layer.

A typical multicolor photographic element comprises a support bearing a cyan dye image-forming unit comprised of at least one red-sensitive silver halide emulsion layer having associated therewith at least one cyan dye-forming coupler, a magenta dye image-forming unit comprising at least one green-sensitive silver halide emulsion layer having associated therewith at least one magenta dye-forming coupler, and a yellow dye-image-forming unit comprising at least one blue-sensitive silver iodobromide emulsion layer having associated therewith at least one yellow dye-forming coupler. At least one of the blue-sensitive silver iodobromide emulsion layers contains Dye 1, Dye 2, the amine borane compound, and the thiosulfonate compound as described above. The element can contain additional layers, such as filter layers, interlayers, overcoat layers, subbing layers, and others known in the art on both sides of the support. If desired, the photographic element can be used in conjunction with an applied magnetic layer as described in Research Disclosure, November 1992, Item 34390 published by Kenneth Mason Publications, Ltd., Dudley Annex, 12a North Street, Emsworth, Hampshire PO 10 7DQ, ENGLAND, the contents of which are incorporated herein by reference. When it is desired to employ the inventive materials in a small format film, Research Disclosure, June 1994, Item 36230, provides suitable embodiments. A particularly useful support for small format film is annealed poly(ethylene naphthalate). Other embodiments of this invention use poly(ethylene terephthalate) or a cellulose acetate as the support material.

In the following discussion of suitable materials for use in the emulsions and elements of this invention, reference will be made to Research Disclosure I (noted above), the contents of which, including the patents and publications referenced therein, are incorporated herein by reference, and the “Sections” hereafter referred to are Sections of Research Disclosure I.

Except as provided, the silver halide emulsion containing elements of this invention can be either negative-working or positive-working as indicated by the type of processing instructions (that is, color negative, reversal, or direct positive processing) provided with the element. In most embodiments, the elements are negative working and are used as consumer color negative films or as motion picture origination films. Suitable emulsions and their preparation as well as methods of chemical and spectral sensitization are described in Sections I through V. Various additives such as UV dyes, brighteners, antifoggants, stabilizers, light absorbing and scattering materials, and physical property modifying addenda such as hardeners, coating aids, plasticizers, lubricants and matting agents are described, for example, in Sections II and VI through VIII. Color materials are described in Sections X through XIII. Suitable methods for incorporating couplers and dyes, including dispersions in organic solvents, are described in Section X(E). Scan facilitating is described in Section XIV. Supports, exposure, development systems, and processing methods and agents are described in Sections XV to XX. Certain desirable photographic elements and processing steps are described in Research Disclosure, Item 37038, February 1995.

Each of the silver halide layers in the elements contains a suitably matched dye-forming color coupler that includes a coupling-off group. Coupling-off groups are well known in the art. Such groups can determine the chemical equivalency of a coupler that is, whether it is a 2-equivalent or a 4-equivalent coupler, or modify the reactivity of the coupler. Such groups can advantageously affect the layer in which the coupler is coated, or other layers in the photographic element, by performing, after release from the coupler, functions such as dye formation, dye hue adjustment, development acceleration or inhibition, bleach acceleration or inhibition, electron transfer facilitation, color correction and the like. The presence of hydrogen at the coupling site provides a 4-equivalent coupler, and the presence of another coupling-off group usually provides a 2-equivalent coupler. Representative classes of such coupling-off groups include, for example, chloro, alkoxy, aryloxy, hetero-oxy, sulfonyloxy, acyloxy, acyl, heterocyclyl such as oxazolidinyl or hydantoinyl, sulfonamido, mercaptotetrazole, benzothiazole, mercaptopropionic acid, phosphonyloxy, arylthio, and arylazo. These coupling-off groups are described in numerous publications, for example, in U.S. Pat. Nos. 2,455,169, 3,227,551, 3,432,521, 3,476,563, 3,617,291, 3,880,661, 4,052,212, and 4,134,766; and in U.K. published applications 1,466,728, 1,531,927, 1,533,039, 2,006,755A and 2,017,704A.

Image dye-forming color couplers may be included in the element such as couplers that form cyan dyes upon reaction with oxidized color developing agents which are described in such representative patents and publications as: U.S. Pat. Nos. 2,367,531, 2,423,730, 2,474,293, 2,772, 162, 2,895,826, 3,002,836, 3,034,892, 3,041,236, 4,333,999, and 4,883,746 and “Farbkuppler-eine LiteratureUbersicht,” published in Agfa Mitteilungen, Band III, pp. 156-175 (1961). Usually, such couplers are phenols and naphthols that form cyan dyes on reaction with oxidized color developing agent.

Couplers that form magenta dyes upon reaction with oxidized color developing agent are described in such representative patents and publications as: U.S. Pat. Nos. 2,311,082, 2,343,703, 2,369,489, 2,600,788, 2,908,573, 3,062,653, 3,152,896, 3,519,429, 3,758,309, and 4,540,654, and “Farbkuppler-eine LiteratureUbersicht,” published in Agfa Mitteilungen, Band III, pp. 126-156 (1961). Usually, such couplers are pyrazolones, pyrazolotriazoles, or pyrazolobenzimidazoles that form magenta dyes upon reaction with oxidized color developing agents.

Couplers that form yellow dyes upon reaction with oxidized and color developing agent are described in such representative patents and publications as: U.S. Pat. Nos. 2,298,443, 2,407,210, 2,875,057, 3,048,194, 3,265,506, 3,447,928, 4,022,620, and 4,443,536, and “Farbkuppler-eine LiteratureUbersicht,” published in Agfa Mitteilungen, Band III, pp. 112-126 (1961). Such couplers are typically open chain ketomethylene compounds.

Couplers that form colorless products upon reaction with oxidized color developing agent are described in such representative patents as: U. K. Patent 861,138 and U.S. Pat. Nos. 3,632,345, 3,928,041, 3,958,993, and 3,961,959. Typically such couplers are cyclic carbonyl containing compounds that form colorless products on reaction with an oxidized color developing agent. Couplers that form black dyes upon reaction with oxidized color developing agent are described in such representative patents as U.S. Pat. Nos. 1,939,231, 2,181,944, 2,333,106, and 4,126,461; and German OLS 2,644,194 and 2,650,764. Typically, such couplers are resorcinols or m-aminophenols that form black or neutral products on reaction with oxidized color developing agent. In addition to the foregoing, so-called “universal” or “washout” couplers may be employed. These couplers do not contribute to image dye-formation. Thus, for example, a naphthol having an unsubstituted carbamoyl or one substituted with a low molecular weight substituent at the 2- or 3-position may be employed. Couplers of this type are described, for example, in U.S. Pat. Nos. 5,026,628, 5,151,343, and 5,234,800.

It may be useful to use a combination of couplers any of which may contain known ballasts or coupling-off groups such as those described in U.S. Pat. Nos. 4,301,235, 4,853,319, and 4,351,897. The coupler may contain solubilizing groups such as described in U.S. Pat. No. 4,482,629. The coupler may also be used in association with “wrong” colored couplers (for example, to adjust levels of interlayer correction) and, in color negative applications, with masking couplers such as those described in EP 213.490, Japanese Published Applications 58-113935 and 58-172,647; U.S. Pat. Nos. 2,983,608, 4,070,191, and 4,273,861; German Applications 2,706,117 and 2,643,965, and U.K. Patent 1,530,272. The masking couplers may be shifted or blocked, if desired.

The couplers are incorporated into suitable silver halide emulsion layers in known amounts.

The invention elements may also contain materials that accelerate or otherwise modify the processing steps for example, bleaching or fixing to improve the quality of the image. Bleach accelerator releasing couplers such as those described in EP 193,389, EP 301,477 and U.S. Pat. Nos. 4,163,669, 4,865,956, and 4,923,784, may be useful. Also contemplated is the use of nucleating agents, development accelerators, or their precursors (UK Patents 2,097,140 and 2,131,188), electron transfer agents (U.S. Pat. Nos. 4,859,578 and 4,912,025), antifogging and anti color-mixing agents such as derivatives of hydroquinones, aminophenols, amines, gallic acid, catechol; ascorbic acid, hydrazides, sulfonamidophenols, and non color-forming couplers.

The elements of this invention can also include one or more development promoting agents such as those described for example in Cols. 7-12 of U.S. Pat. No. 6,699,652B1 (Johnston et al.) that is incorporated herein by reference. Such compounds are generally incorporated in close association with the yellow dye-forming unit prepared according to this invention.

The elements of this invention may also include filter dye layers comprising colloidal silver sol or yellow, cyan, or magenta filter dyes, either as oil-in-water dispersions, latex dispersions or as solid particle dispersions. Additionally, they may be used with “smearing” couplers (for example, as described in U.S. Pat. Nos. 4,366,237, 4,420,556, and 4,543,323.). In particular, the elements of this invention can include a yellow filter dye in a layer between the support and the green sensitized layer closest to the support, such as the filter dye defined by the following structure:

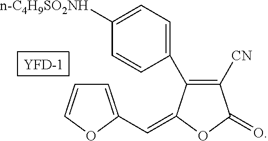

The invention elements may further include image-modifying compounds such as “Developer Inhibitor-Releasing” compounds (DIR's) that are known in the art as described for example, in U.S. Pat. Nos. 3,137,578; 3,148,022; 3,148,062; 3,227,554; 3,384,657; 3,379,529; 3,615,506; 3,617,291; 3,620,746; 3,701,783; 3,733,201; 4,049,455; 4,095,984; 4,126,459; 4,149,886; 4,150,228; 4,211,562; 4,248,962; 4,259,437; 4,362,878; 4,409,323; 4,477,563; 4,782,012; 4,962,018; 4,500,634; 4,579,816; 4,607,004; 4,618,571; 4,678,739; 4,746,600; 4,746,601; 4,791,049; 4,857,447; 4,865,959; 4,880,342; 4,886,736; 4,937,179; 4,946,767; 4,948,716; 4,952,485; 4,956,269; 4,959,299; 4,966,835; 4,985,336 as well as GB 1,560,240; GB 2,007,662; GB 2,032,914; GB 2,099,167; DE 2,842,063, DE 2,937,127; DE 3,636,824; DE 3,644,416, and European Patent Publications 272,573; 335,319; 336,411; 346,899; 362,870; 365,252; 365,346; 373,382; 376,212; 377,463; 378,236; 384,670; 396,486; 401,612; 401,613. Such compounds are also disclosed in “Developer-Inhibitor-Releasing (DIR) Couplers for Color Photography,” C. R. Barr, J. R. Thirtle and P. W. Vittum in Photographic Science and Engineering, Vol. 13, p. 174 (1969), incorporated herein by reference. Generally, the developer inhibitor-releasing (DIR) couplers include a coupler moiety and an inhibitor coupling-off moiety (IN). The inhibitor-releasing couplers may be of the time-delayed type (DIAR couplers) that also includes a timing moiety or chemical switch that produces a delayed release of inhibitor.

The photographic elements of this invention can also include one or more preformed magenta dyes that are present in an amount to provide a status M green density greater than 0.005 per mg/m². The generic description of such dyes and a number of examples including MD-1 through MD-16 are provided in U.S. Pat. No. 7,632,632 (Zengerle et al.) that is incorporated herein by reference.

Alternatively, or additionally, to the use of the preformed magenta dyes, the photographic elements of this invention can include one or more preformed yellow colorants in an amount to provide a status M blue density greater than 0.003 per mg/m². The generic description of such dyes and a number of examples including YD-1 through YD-17 are described in U.S. Pat. No. 7,629,112 (Zengerle et al.) that is incorporated herein by reference.

The silver halides used in the various silver halide emulsion layers other than the blue-sensitive emulsion layer containing Dye 1 and Dye 2, may be silver iodobromide, silver bromide, silver chloride, silver chlorobromide, silver chloroiodobromide, and others known in the art, or mixtures thereof. In naming grains and emulsions containing two or more halides, the halides are named in order of ascending concentrations. The one or more blue-sensitive silver halide emulsion layers containing Dye 1, Dye 2, the amine borane compound, and the thiosulfonate compound contain silver iodobromide grains that have at least 1 and up to and including 15 mol % silver iodide, or typically from about 2 to about 8 mol % of silver iodide. These silver iodobromide grains comprise at least 50 mol % of all of the silver in the blue-sensitive emulsion layer. Other silver halide grains can be present also in “minor” (less than 50 mol % silver) amounts. In addition, the other silver halide emulsion layers, such as the red-sensitive and green-sensitive silver halide emulsion layers can have the same or different types of silver halide grains as are already known in the art.

The grain size of the silver halides used in the various silver halide emulsion layers of the elements may have any distribution known to be useful in photographic compositions, and may be either polydispersed or monodispersed. The silver halide grains to be used in the invention may be prepared according to methods known in the art, such as those described in Research Disclosure I and The Theory of the Photographic Process, 4th edition, T. H. James, editor, Macmillan Publishing Co., New York, 1977. These include methods such as ammoniacal emulsion making, neutral or acidic emulsion making, and others known in the art. These methods generally involve mixing a water soluble silver salt with a water soluble halide salt in the presence of a protective colloid (such as a gelatin), and controlling the temperature, pAg, pH values, etc., at suitable values during formation of the silver halide by precipitation.

Especially useful in this invention in the blue-sensitive silver iodobromide emulsion layers are radiation-sensitive tabular grain silver iodobromide emulsions. Such tabular grains are silver iodobromide grains having parallel major faces and an aspect ratio of at least 2 and up to 40 and typically from about 4 to about 30, where aspect ratio is the ratio of grain equivalent circular diameter (ECD) divided by grain thickness (t). The equivalent circular diameter of a grain is the diameter of a circle having an average equal to the projected area of the grain. A tabular grain emulsion is one in which tabular grains account for greater than 50 percent of total grain projected area. In most tabular grain emulsions, tabular grains account for at least 70 percent of total grain projected area and desirably at least 90 percent of total grain projected area. It is possible to prepare tabular grain emulsions in which substantially all (at least 97%) of the grain projected area is accounted for by tabular grains. The non-tabular grains in a tabular grain emulsion can take any convenient conventional form. When co-precipitated with the tabular grains, the non-tabular grains typically exhibit a silver halide composition the same as the tabular grains.

The other silver halide emulsion layers can comprise silver halide grains of any useful morphology and halide composition. Generally, the green- and red-sensitive silver halide emulsion layers also comprise tabular silver halide grains, and those grains can be high bromide or high chloride silver halide grains. In many embodiments, they are high bromide grains in which at least 50 mol % of the silver halide is silver bromide. Such tabular grains can accommodate iodide up to its solubility limit in the face centered cubic crystal lattice structure of the grains. The solubility limit of iodide in a silver bromide crystal lattice structure is approximately 40 mole percent, based on silver. The solubility limit of iodide in a silver chloride crystal lattice structure is approximately 11 mole percent, based on silver. The exact limits of iodide incorporation can be somewhat higher or lower, depending upon the specific technique employed for silver halide grain preparation. In practice, useful photographic performance advantages can be realized with iodide concentrations as low as 0.1 mole percent, based on silver. It is usually desired to incorporate at least 0.5 (optimally at least 1.0) mole percent iodide, based on silver. Overall iodide concentrations of up to 20 mole percent, based on silver, are well known, but it is generally desired to limit iodide to 15 mole percent, based on silver.

Iodide can be uniformly or non-uniformly distributed within the tabular grains. Both uniform and non-uniform iodide concentrations are known to contribute to photographic speed. For maximum speed it is common practice to distribute iodide over a large portion of a tabular grain while increasing the local iodide concentration within a limited portion of the grain. It is also common practice to limit the concentration of iodide at the surface of the grains. For example, the surface iodide concentration of the grains may be less than 5 mole percent, based on silver. Surface iodide is the iodide that lies within 0.02 nm of the grain surface.

When tabular grain emulsions are spectrally sensitized according to this invention, it is desired to limit the average thickness of the tabular grains to less than 0.3 μm, or typically less than 0.2 μm. In some embodiments, the tabular grains are ultrathin—that is, their average thickness is less than 0.07 μm. The useful average grain ECD of a tabular grain emulsion can range up to about 15 μm but it is generally it is up to 10 μm.

The average aspect ratio of the tabular grain emulsions used in the red- and green-sensitive silver halide emulsion layers is generally greater than 5 and up to 50.

The tabular grains used in any emulsion layer of this invention can have parallel major faces that lie in either {100} or {111} crystal lattice planes. In other words, both {111} tabular grain emulsions and {100} tabular grain emulsions are within the specific contemplation of this invention. The {111} major faces of {111} tabular grains appear triangular or hexagonal in photomicrographs while the {100} major faces of {100} tabular grains appear square or rectangular. In their most widely used form tabular grain emulsions are high bromide {111} tabular grain emulsions. Such emulsions are illustrated by in numerous patents including those cited in Column 30 (lines 35-64) of U.S. Pat. No. 6,699,652 (noted above) and incorporated herein by reference. Ultrathin high bromide {111} tabular grain emulsions are illustrated by numerous patents also, including those described in Column 30, lines 57-64 of U.S. Pat. No. 6,699,652 (noted above). High bromide {100} tabular grain emulsions are described in U.S. Pat. Nos. 4,386,156 and 5,386,156 (both Mignot) and U.S. Pat. No. 5,726,006 (Gourlaouen et al.).

Localized peripheral incorporations of higher iodide concentrations can also be created by halide conversion. By controlling the conditions of halide conversion by iodide, differences in peripheral iodide concentrations at the grain corners and elsewhere along the edges can be realized.

The silver halide emulsions used in this invention, and especially the silver iodobromide emulsions in the blue-sensitive emulsion layers, may comprise tabular silver halide grains having surface chemical sensitization sites including at least one silver salt forming epitaxial junction with the tabular grains and being restricted to those portions of the tabular grains located nearest peripheral edges. The silver halide tabular grains of the photographic material may be prepared with a maximum surface iodide concentration along the edges and a lower surface iodide concentration within the corners than elsewhere along the edges. Chemical sensitization can be carried out using known procedures and chemicals, but for the silver iodobromide grains in the blue-sensitive silver iodobromide emulsion layers described for the present invention, the silver iodobromide grains (such as tabular silver iodobromide grains) can be chemically sensitized with sulfur, gold, or both sulfur and gold, using known sources of these elements. Sulfur chemical sensitization of the blue-sensitive silver iodobromide grains is described below in the Examples.

In the course of grain precipitation one or more dopants (grain occlusions other than silver and halide) can be introduced to modify grain properties. For example, any of the various conventional dopants disclosed in Research Disclosure, Item 38957, Section I. Emulsion grains and their preparation, sub-section G. Grain modifying conditions and adjustments, paragraphs (3), (4) and (5), can be present in the emulsions of the invention. Especially useful dopants are disclosed by U.S. Pat. Nos. 4,937,180 (Marchetti et al.) and 5,164,292 (Johnson et al.). In addition, it is contemplated to dope the grains with transition metal hexacoordination complexes containing one or more organic ligands as taught in U.S. Pat. No. 5,360,712 (Olm et al.).

It is also contemplated to incorporate in the face centered cubic crystal lattice of the grains a dopant capable of increasing imaging speed by forming a shallow electron trap (hereinafter also referred to as a SET) as discussed in Research Disclosure Item 36736 published November 1994. SET dopants are known to be effective to reduce reciprocity failure. In particular the use of Ir⁺³ or Ir⁺⁴ hexacoordination complexes as SET dopants is advantageous. Iridium dopants that are ineffective to provide shallow electron traps (non-SET dopants) can also be incorporated into the grains of the silver halide grains to reduce reciprocity failure. The contrast of the photographic element can be further increased by doping the grains with a hexacoordination complex containing a nitrosyl or thionitrosyl ligand (NZ dopants) as disclosed in U.S. Pat. No. 4,933,272 (McDugle et al.).

The photographic elements of this invention can be prepared according to this invention by preparing a blue-sensitive silver iodobromide emulsion by mixing silver iodobromide grains having an aspect ratio of from about 2 to about 40 and comprising at least 1 and up to and including 15 mol % iodide, individually:

(a) an anionic blue spectral sensitizing Dye 1 to provide an inner dye layer adjacent the silver halide grains,

(b) a cationic blue spectral sensitizing Dye 2 to provide an outer dye layer adjacent to the inner dye layer,

wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,

(c) an amine borane compound in an amount of from about 0.03 to about 0.5 μmol per mol of silver iodobromide, and

(d) from about 0.8 to about 4 μmol per mol of silver iodobromide of a thiosulfonate compound having the structure:

R¹—SO₂S-M¹

wherein R¹ represents an aliphatic, carbocyclic, or heterocylic group and M¹ represents a mono-, di-, or tri-valent cation, and

applying the blue-sensitive silver halide emulsion to a support.

For example, the amine borane compound can be mixed with the silver iodobromide grains prior to the mixing of a first portion of the thiosulfonate compound.

In other embodiments, the amine borane compound and thiosulfate compound are mixed with the silver iodobromide grains prior to the mixing of Dye 1 with the silver iodobromide grains.

Further, a second portion of the thiosulfate compound can be mixed with the silver iodobromide grains after the mixing of the Dye 1 with the silver iodobromide grains, and before chemical sensitization of the silver iodobromide grains with sulfur, gold, or both sulfur and gold.

In general, the Dye 2 is added after the silver iodobromide grains are chemically sensitized with sulfur, gold, or both sulfur and gold, for example, after the silver iodobromide grains are treated by heating them to a temperature of from about 50 to about 70° C., holding the silver iodobromide grains at the temperature for at least 3 and up to and including 60 minutes, and cooling the silver iodobromide grains to a temperature of from about 35 to about 45° C.

In many embodiments, the blue-sensitive silver iodobromide emulsion is prepared using the following sequence of steps:

(a′) mixing the silver iodobromide grains with the amine borane compound,

(b′) mixing the silver iodobromide grains with a first portion of a thiosulfonate compound,

(c′) mixing the silver iodobromide grains with the Dye 1,

(d′) mixing the silver iodobromide grains with a second portion of a thiosulfonate compound,

(e′) chemically sensitizing the silver halide grains with sulfur, gold, or both sulfur and gold,

(f′) treating the silver iodobromide grains by: heating them to a temperature of from about 50 to about 70° C., holding the silver iodobromide grains at the temperature for at least 3 and up to and including 60 minutes, and cooling the silver iodobromide grains to a temperature of from about 35 to about 45° C., and

(g′) mixing the silver iodobromide grains with the Dye 2.

Further, a benzothiazolium or acetamido-mercaptotetrazole compound, or both types of compounds, can be added to the silver iodobromide grains between steps (e′) and (f′) as an antifoggant. These and similar useful antifoggants are known in the art.

Alternatively, or in addition to the previous steps, a traazaindene compound can be added to the silver iodobromide grains between steps (f′) and (g′) in an amount of from about 3 to about 20 mol per mol of silver iodobromide.

The blue-sensitive silver iodobromide emulsion can be prepared by mixing the amine borane compound with the silver iodobromide grains prior to the mixing of a first portion of the thiosulfonate compound that is at least as large or larger than a second portion of the thiosulfonate compound that is added at a later stage of the process.

In addition, the amine borane compound and thiosulfonate compound are generally mixed with the silver iodobromide grains prior to the mixing of Dye 1 with the silver iodobromide grains.

Then, a second portion of the thiosulfonate compound can be mixed with the silver iodobromide grains after the mixing of the Dye 1 with the silver iodobromide grains, and before chemical sensitization of the silver iodobromide grains with sulfur, gold, or both sulfur and gold. The Dye 2 can then be added to the silver iodobromide grains.

As noted above, the noted method can be carried out using first and second portions of the same or different thiosulfonate compound that are provided in a weight ratio to each other of from about 2:1 to about 1:2. In most embodiments, the first portion of the thiosulfate compound is at least as large as or larger than the second portion of the thiosulfonate compound. Moreover, in most embodiments, the same thiosulfonate compound is used in the first and second portions.

### Exposure and Processing to Color Images

Photographic elements can be exposed to actinic radiation, typically in the visible region of the spectrum, to form a latent image and can then be processed to form a visible dye image. For example, motion picture films of this invention can be exposed to any suitable source of actinic radiation, such as a tungsten light source, to provide latent images.

Processing to form a visible dye image includes the step of contacting the imagewise exposed element with a color developing agent to reduce developable silver halide (including the silver iodobromide grains) and to oxidize the color developing agent. Oxidized color developing agent in turn reacts with the coupler to yield a dye. With negative-working silver halide, the processing step described above provides a negative image. One type of such element, referred to as a color negative film, is designed for image capture. Such elements are typically silver iodobromide emulsions coated on a transparent support and are sold packaged with instructions to process in known color negative processes such as the Kodak C-41 process as described in The British Journal of Photography Annual of 1988, pages 191-198.

If a color negative film element is to be subsequently employed to generate a viewable projection print (motion picture film) as for a motion picture, a process such as the Kodak ECN-2 process described in the H-24 Manual available from Eastman Kodak Co. may be employed to provide the color negative image on a transparent support. Color negative development times are typically 3′15″ or less and desirably 90 or even 60 seconds or less.

The photographic element of the invention can be incorporated into exposure structures intended for repeated use or exposure structures intended for limited use, variously referred to by names such as “one time use camera”, “single use cameras”, “lens with film”, or “photosensitive material package units”.

Useful color developing agents are p-phenylenediamines such as: 4-amino-N,N-diethylaniline hydrochloride, 4-amino-3-methyl-N,N-diethylaniline hydrochloride, 4-amino-3-methyl-N-ethyl-N-(2-methanesulfonamidoethyl)aniline sesquisulfate hydrate, 4-amino-3-methyl-N-ethyl-N-(2-hydroxyethyl)aniline sulfate, 4-amino-3-(2-methanesulfonamidoethyl)-N,N-diethylaniline hydrochloride and 4-amino-N-ethyl-N-(2-methoxyethyl)-m-toluidine di-p-toluene sulfonic acid.

Development is usually followed by the conventional steps of bleaching, fixing, or bleach-fixing, to remove silver or silver halide, washing, and drying.

The following Examples are provided to illustrate the practice of this invention but they are not meant to be limiting in any manner.

In these examples, yellow dye-forming color couplers Y-1 and Y-2 have the structure shown in Invention Example 7 below. Dye 1 and Dye 2 are also shown in Invention Example 7

### Invention Example 1

Film coating evaluations were carried out in a blue-sensitive photographic color film using a sulfur- and gold-sensitized 2.2 μm×0.14 μm silver iodobromide tabular emulsion containing 4.9 mol % silver iodide. Six emulsion melts were prepared. Each emulsion melt (0.07 mole Ag) was heated to 43° C. and sodium thiocyanate (70 mg/Ag mole) was added. After a 5 minute hold, either no reducing agent was added (Film Samples 1-1, 1-2, 1-4, and 1-6) or 0.08 μmole/mole Ag of t-butylamine borane (TBAB) (Film Samples 1-3 and 1-5) was added followed by a 2 minute hold. Then, either no oxidizing agent was added (Film Samples 1-1, 1-2, 1-4, and 1-6) or 1.3 μmole/mole Ag of potassium 4-methylbenzenethiosulfonate (TSS) (Film Samples 1-3 and 1-5) was added. After a 2 minute hold, 0.82 mmole/Ag mole of sensitizing Dye 1 was added followed by a 10 minute hold. This was followed by either no addition (Film Samples 1-1, 1-2, 1-4, and 1-6) or by adding a second portion of 1.3 μmole/Ag mole potassium 4-methylbenzenethiosulfonate (Film Samples 1-3 and 1-5) with a subsequent 2 minute hold. This was followed by the addition of sodium aurous dithiosulfate dehydrate (1.72 mg/Ag mole). After a 2 minute hold, sodium thiosulfate pentahydrate (0.81 mg/Ag mole) was added, followed by a 2 minute hold. Then, 3-(2-methylsulfamoylethyl)-benzothiazolium tetrafluoroborate (30 mg/Ag mole) was added. Following a 2 minute hold, 1-(3-acetamidophenyl)-5-mercaptotetrazole (10 mg/Ag mole) was added with a subsequent 2 minute hold. Each emulsion was heated to 63° C. and held for 10 minutes. After cooling to 43° C., either no reducing agent was added (Film Samples 1-1, 1-2, 1-3, and 1-5) or 2 mg/mole Ag of 2-(N-propynyl)aminobenzoxazole (PAB) (Film Samples 1-4 and Example 1-6) was added. Following a 2 minute hold, either no aurous sulfide (AuS) was added (Film Samples 1-1, 1-2, 1-3, and 1-5) or 2 mg/mole Ag of the gold sulfide (Film Samples 1-4 and Example 1-6) was added with a subsequent 2 minute hold. Next, 4-hydroxy-6-methyl-1,3,3a,7-tetraazaindene, sodium salt, monohydrate, (2.5 g/Ag mole) was added and then held for 3 minutes. Then, either no Dye 2 (Film Samples 1-1, 1-3, and 1-4) was added or 1.0 mmole/mole Ag of Dye 2 was added (Film Samples 1-2, 1-5, and 1-6) followed by a 20 minutes hold. Each emulsion was subsequently chilled to 5° C. Before coating, the emulsion was combined with gelatin and distilled water; and subsequently heated to 40° C. to mix components. Single blue-sensitive silver halide emulsion layer coatings were made on an acetate support to provide a silver lay down of 861 mg/m². Before coating each melt was combined with a coupler dispersion containing two yellow forming couplers, Y-1 and Y-2, at a 1:1 weight ratio, to provide a total coupler lay down of 430.6 mg/m². The gelatin coating lay down was 2153 mg/m².

A hardened overcoat of 1200 mg/m² was applied to the coated silver iodobromide layer. Sensitometric exposures (0.02 second) were carried out using tungsten exposure with filtration through 0.6 Inconel and Wratten 2b filters. The resulting photographic film elements were processed for 3.25 minutes in the known ECN-2 color process. The results are shown below in TABLE I.

TABLE I

| | | | | Relative |
|---|---|---|---|---|
| Film Sample | Comments | Dₘᵢₙ | Speed¹ | Speed² |
| 1-1 | Comparison | 0.09 | 188 | 1.00 |
| Dye 1 | | | | |
| 1-2 | Comparison | 0.11 | 251 | 1.34 |
| Dye 1 & Dye 2 | | | | |
| 1-3 | Comparison | 0.11 | 303 | 1.61 |
| Dye 1, TBAB, & TSS | | | | |
| 1-4 | Comparison | 0.09 | 257 | 1.37 |
| Dye 1, PAB, & AuS | | | | |
| 1-5 | Invention | 0.12 | 436 | 2.32 |
| Dye 1, TBAB, TSS, & | | | | |
| Dye 2 | | | | |
| 1-6 | Comparison | 0.10 | 307 | 1.63 |
| Dye 1, PAB, AuS, & | | | | |
| Dye 2 | | | | |

¹Speed numbers were calculated from the reciprocal of the exposure in lux-seconds required to produce a density of 0.10 above Dₘᵢₙ.
²Speed relative to Comparison Film Sample 1-1 wherein the emulsion did not have any reduction sensitization and one dye layer with Dye 1.

It can be seen from the results in TABLE I that the Invention emulsion (Film Sample 1-5) that contained the combination of reduction sensitization with TBAB and Dye 2 provides higher sensitivity than the comparative emulsion (Film Sample 1-6) that contained the combination of PAB, AuS, and Dye 2. The Invention emulsion (Film Sample 1-5) provided about 132% higher sensitivity compared to the reference emulsion (Film Sample 1-1), and 44% higher sensitivity compared to the comparative emulsion (Film Sample 1-3) that contained only the TBAB and TSS compounds. The comparative emulsion (Film Sample 1-6) showed about 63% higher sensitivity compared to the reference emulsion (Film Sample 1-1) or 19% higher sensitivity than the comparative emulsion (Film Sample 1-4) that contained only the PAB and AuS compounds. The increase in sensitivity that was provided to the comparative emulsion (Film Sample 1-2) that contained Dye 2 was about 34% compared to the reference emulsion (Film Sample 1-1).

### Invention Example 2

Film coating evaluations were carried out in blue-sensitive color photographic film using a sulfur- and gold-sensitized 2.2 μm×0.14 μm silver iodobromide tabular emulsion containing 4.9 mol % silver iodide. Nine emulsion melts were prepared. Each emulsion melt (0.07 mole Ag) was heated to 43° C. and sodium thiocyanate (70 mg/Ag mole) was added. After a 5 minute hold, either no reducing agent was added (Film Samples 2-1 and 2-2) or 0.034 (Film Sample 2-4), 0.057 (Film Sample 2-5), 0.08 (Film Samples 2-3 and 2-6), 0.10 (Film Sample 2-7), 0.13 (Film Sample 2-8), or 0.15 (Film Sample 2-9) μmole/mole Ag of t-butylamine borane (TBAB) was added followed by a 2 minute hold. Then, either no oxidizing agent was added (Film Samples 2-1 and 2-2) or 1.3 mmole/mole Ag of potassium 4-methylbenzenethiosulfonate (TSS) (Film Samples 2-3, 2-4, 2-5, 2-6, 2-7, 2-8, and 2-9) was added. After a 2 minute hold, 0.84 mmole/Ag mole of sensitizing Dye 1 was added followed by a 10 minute hold. This was followed by either no addition (Film Samples 2-1 or 2-2) or by adding a second portion of 1.3 mmole/Ag mole potassium 4-methylbenzenethiosulfonate (Film Samples 2-3, 2-4, 2-5, 2-6, 2-7, 2-8, or 2-9) with a subsequent 2 minute hold. This was followed by the addition of sodium aurous dithiosulfate dehydrate (1.72 mg/Ag mole). After a 2 minute hold, sodium thiosulfate pentahydrate (0.81 mg/Ag mole) was added, followed by a 2 minute hold. Then, 3-(2-methylsulfamoylethyl)-benzothiazolium tetrafluoroborate (30 mg/Ag mole) was added. Following a 2 minute hold, 1-(3-acetamidophenyl)-5-mercaptotetrazole (10 mg/Ag mole) was added with a subsequent 2 minute hold. Each emulsion was heated to 63° C. and held for 10 minutes. After cooling to 43° C., 4-hydroxy-6-methyl-1,3,3a,7-tetraazaindene, sodium salt, monohydrate, (2.5 g/Ag mole) was added and then held for 3 minutes. Then, either no Dye 2 (Film Samples 2-1 and 2-3) was added or 1.0 mmole/mole Ag of Dye 2 was added (Film Samples 2-2, 2-3, 2-4, 2-5, 2-6, 2-7, 2-8, and 2-9) followed by a 20 minutes hold. Each melt was subsequently chilled to 5° C. Before coating, each emulsion was combined with gelatin and distilled water; and subsequently heated to 40° C. to mix components. Single-layer coatings were made on an acetate support to provide a silver lay down of 861 mg/m². Before coating, each silver melt was combined with a coupler dispersion containing two yellow forming couplers, Y-1 and Y-2 at a 1:1 weight ratio to provide a total lay down of 430.6 mg/m². The gelatin lay down was 2153 mg/m².

A hardened overcoat was applied to the coated emulsion layer to provide a dry coverage of 1200 mg/m². Sensitometric exposures (0.02 second) were carried out using tungsten exposure with filtration through 0.6 Inconel and Wratten 2b filters. The resulting color photographic elements were processed for 3.25 minutes in the known ECN-2 color process. The results are shown below in TABLE II.

TABLE II

| | | Relative TBAB | Relative TSS | | | Relative |
|---|---|---|---|---|---|---|
| Film Sample | | Amount Added | Amount Added | Dₘᵢₙ | Speed¹ | Speed² |
| Dye 1 | Reference | 0 | 0 | 0.09 | 204 | 1.00 |
| | 2-1 | | | | | |
| Dye 1 & Dye 2 | Comparison | 0 | 0 | 0.10 | 253 | 1.24 |
| | 2-2 | | | | | |
| Dye 1 & TBAB/TSS | Comparison | 1.00 | 1.0 | 0.12 | 270 | 1.32 |
| | 2-3 | | | | | |
| Dye 1 & TBAB/TSS & | Invention | 0.43 | 1.0 | 0.10 | 316 | 1.55 |
| Dye 2 | 2-4 | | | | | |
| Dye 1 & TBAB/TSS & | Invention | 0.71 | 1.0 | 0.12 | 336 | 1.65 |
| Dye 2 | 2-5 | | | | | |
| Dye 1 & TBAB/TSS & | Invention | 1.00 | 1.0 | 0.12 | 400 | 1.96 |
| Dye 2 | 2-6 | | | | | |
| Dye 1 & TBAB/TSS & | Invention | 1.29 | 1.0 | 0.12 | 406 | 1.99 |
| Dye 2 | 2-7 | | | | | |
| Dye 1 & TBAB/TSS & | Invention | 1.57 | 1.0 | 0.14 | 411 | 2.01 |
| Dye 2 | 2-7 | | | | | |
| Dye 1 & TBAB/TSS & | Invention | 1.86 | 1.0 | 0.16 | 411 | 2.01 |
| Dye 2 | | | | | | |

¹Speed numbers were calculated from the reciprocal of the exposure in lux-seconds required to produce a density of 0.10 above Dₘᵢₙ.
²Speed relative to Comparison Film Sample 2-1 wherein the emulsion did not have any reduction sensitization and spectral sensitized using only Dye 1.

It can be seen from the results of TABLE II that the Invention emulsions (Film Samples 2-4, 2-5, 2-6, 2-7, 2-8, and 2-9) that contained Dye 2 and increasing amounts of reduction sensitization with TBAB provided increasing sensitivity compared to the comparative emulsions (Film Samples 2-1, 2-2, and 2-3). The sensitivity of the Invention emulsions (Film Samples 2-6 and 2-7) reached a maximum value of about 0.08 to 0.10 mmole/mole Ag of TBAB. Invention emulsions (Film Samples 2-8 and 2-9) with TBAB amount greater than 0.10 mmole/mole Ag resulted in higher fog or minimum density.

### Invention Example 3

Film coating evaluations were carried out in blue-sensitive color photographic film using a sulfur- and gold-sensitized 3.4 μm×0.14 μm silver iodobromide tabular emulsion containing 4.9 mol % silver iodide. Six emulsion melts were prepared. Each emulsion melt (0.07 mole Ag) was heated to 43° C. and sodium thiocyanate (75 mg/Ag mole) was added. After a 5 minute hold, either no reducing agent was added (Film Samples 3-1, 3-3, and 3-5) or 0.08 mmole/mole Ag of t-butylamine borane (TBAB) (Film Samples 3-2 or 3-4) was added followed by a 2 minute hold. Then, either no oxidizing agent was added (Film Samples 3-1, 3-3, and 3-5) or 1.3 mmole/mole Ag of potassium 4-methylbenzenethiosulfonate (TSS) (Film Samples 3-2 and 3-4) was added. After a 2 minute hold, 0.8 mmole/Ag mole of sensitizing Dye 1 was added followed by a 10 minute hold. This was followed by either no addition (Film Samples 3-1, 3-3, and 3-5) or by adding a second portion of 1.3 mmole/Ag mole potassium 4-methylbenzenethiosulfonate (Film Samples 3-2 or 3-4) with a subsequent 2 minute hold. This was followed by the addition of sodium aurous dithiosulfate dehydrate (1.54 mg/Ag mole). After a 2 minute hold, sodium thiosulfate pentahydrate (0.73 mg/Ag mole) was added, followed by a 2 minute hold. Then, 3-(2-methylsulfamoylethyl)-benzothiazolium tetrafluoroborate (30 mg/Ag mole) was added. Following a 2 minute hold, 1-(3-acetamidophenyl)-5-mercaptotetrazole (14 mg/Ag mole) was added with a subsequent 2 minute hold. Each emulsion was heated to 63° C. and held for 11 minutes. After cooling to 43° C., either no reducing agent was added (Film Samples 3-1, 3-2, and 3-4) or 2 mg/mole Ag of 2-(N-propynyl)aminobenzoxazole (PAB) (Film Samples 3-3 and 3-5) was added. Following a 2 minute hold, either no aurous sulfide (AuS) was added (Film Samples 3-1, 3-2, or 3-4) or 3 mg/mole Ag of the gold sulfide (Film Samples 3-3 and 3-5) was added with a subsequent 2 minute hold. Next, 4-hydroxy-6-methyl-1,3,3a,7-tetraazaindene, sodium salt, monohydrate, (2.5 g/Ag mole) was added and then held for 3 minutes. Then, either no Dye 2 (Film Samples 3-1, 3-2, and 3-3) was added or 0.9 mmole/mole Ag of Dye 2 was added (Film Samples 3-4 and 3-5) followed by a 20 minute hold. The emulsion was subsequently chilled to 5° C. Before coating, each emulsion was combined with gelatin and distilled water; and subsequently heated to 40° C. to mix components. Single-layer coatings were made on an acetate support to provide a silver lay down of 861 mg/m². Each silver melt was combined with a coupler dispersion containing two yellow forming couplers, Y-1 and Y-2 at a 1:1 weight ratio for a total lay down of 430.6 mg/m². The gelatin lay down was 2153 mg/m².

A hardened overcoat was applied to the coated emulsion layer at 1200 mg/m². Sensitometric exposures (0.02 second) were carried out using tungsten exposure with filtration through 0.6 Inconel and Wratten 2b filters. The resulting photographic film elements were processed for 3.25 minutes in the known ECN-2 color process. The results are shown below in TABLE III.

TABLE III

| | | | | Relative |
|---|---|---|---|---|
| Film Sample | Comments | Dₘᵢₙ | Speed¹ | Speed² |
| 3-1 | Comparison | 0.10 | 290 | 1.00 |
| Dye 1 | | | | |
| 3-2 | Comparison | 0.12 | 434 | 1.50 |
| Dye 1 & TBAB/TSS | | | | |
| 3-3 | Comparison | 0.11 | 440 | 1.52 |
| Dye 1 & PAB/AuS | | | | |
| 3-4 | Invention | 0.14 | 592 | 2.04 |
| Dye 1, TBAB/TSS & | | | | |
| Dye 2 | | | | |
| 3-5 | Comparison | 0.10 | 463 | 1.60 |
| Dye 1 & PAB/Aus & | | | | |
| Dye 2 | | | | |

¹Speed numbers were calculated from the reciprocal of the exposure in lux-seconds required to produce a density of 0.10 above Dₘᵢₙ.
²Speed relative to Comparison Film Sample 3-1 wherein the emulsion did not have any reduction sensitization and was spectrally sensitized using only Dye 1.

It can be seen from the results of TABLE III that the Invention emulsion (Film Sample 3-4) that contained the combination of reduction sensitization with TBAB and Dye 2 provided higher sensitivity than the comparative emulsion (Film Sample 3-5) that contained the combination of PAB, AuS, and Dye 2. The Invention emulsion (Film Sample 3-4) resulted in about 104% higher sensitivity compared to the reference emulsion (Film Sample 3-1) or 36% higher sensitivity compared to the comparative emulsion (Film Sample 3-2) that contained only the TBAB and TSS compounds. The comparative emulsion (Film Sample 3-5) showed about 60% higher sensitivity compared to the reference emulsion (Film Sample 3-1) or 5% higher sensitivity than the comparative emulsion (Film Sample 3-3) that contained only the PAB and AuS compounds.

### Invention Example 4

Film coating evaluations were carried out in blue-sensitive color photographic film using a sulfur- and gold-sensitized 3.4 μm×0.14 μm silver iodobromide tabular emulsion containing 4.9 mol % silver iodide. Six emulsion melts were prepared. Each emulsion melt (0.07 mole Ag) was heated to 43° C. and sodium thiocyanate (70 mg/Ag mole) was added. After a 5 minute hold, either no reducing agent was added (Film Samples 4-1 and 4-2) or 0.057 (Film Sample 4-4), 0.080 (Films Samples 4-3 and 4-5), or 0.10 (Film Sample 4-6) μmole/mole Ag of t-butylamine borane (TBAB) was added followed by a 2 minute hold. Then, either no oxidizing agent was added (Film Samples 4-1 or 4-2) or 1.3 mmole/mole Ag of potassium 4-methylbenzenethiosulfonate (TSS) (Film Samples 4-3, 4-4, 4-5, and 4-6) was added. After a 2 minute hold, 0.80 mmole/Ag mole sensitizing Dye 1 was added followed by a 10 minute hold. This was followed by either no addition (Film Samples 4-1 and 4-2) or adding a second portion of 1.3 mmole/Ag mole potassium 4-methylbenzenethiosulfonate (Film Samples 4-3, 4-4, 4-5, and 4-6) with a subsequent 2 minute hold. This was followed by the addition of sodium aurous dithiosulfate dehydrate (1.53 mg/Ag mole). After a 2 minute hold, sodium thiosulfate pentahydrate (0.72 mg/Ag mole) was added, followed by a 2 minute hold. Then, 3-(2-methylsulfamoylethyl)-benzothiazolium tetrafluoroborate (35 mg/Ag mole) was added. Following a 2 minute hold, 1-(3-acetamidophenyl)-5-mercaptotetrazole (13 mg/Ag mole) was added with a subsequent 2 minute hold. Each emulsion was heated to 63° C. and held for 10 minutes. After cooling to 43° C., 4-hydroxy-6-methyl-1,3,3a,7-tetraazaindene, sodium salt, monohydrate, (2.5 g/Ag mole) was added and then held for 3 minutes. Then, either no Dye 2 (Film Samples 4-1 and 4-3) was added or 0.9 mmole/mole Ag of Dye 2 was added (Film Samples 4-2, 4-4, 4-5, and 4-6) followed by a 20 minutes hold. Each emulsion was subsequently chilled to 5° C. Before coating, each emulsion melt was combined with gelatin and distilled water; and subsequently heated to 40° C. to mix components. Single-layer coatings were made on an acetate support to provide a silver lay down of 861 mg/m². Each silver melt was combined with a coupler dispersion containing two yellow forming couplers, Y-1 and Y-2 at a 1:1 weight ratio for a total lay down of 430.6 mg/m². The gelatin lay down was 2153 mg/m².

A hardened overcoat was applied over the coated emulsion layer at 1200 mg/m². Sensitometric exposures (0.02 second) were carried out using tungsten exposure with filtration through 0.6 Inconel and Wratten 2b filters.

The described color photographic film elements were processed for 3.25 minutes in the known ECN-2 color process. The results are shown below in TABLE IV.

TABLE IV

| Film | | | Relative TBAB | Relative TSS | | | Relative |
|---|---|---|---|---|---|---|---|
| Samples | | | Amount Added | Amount Added | Dₘᵢₙ | Speed¹ | Speed² |
| 4-1 | Dye 1 | Comparison | 0 | 0 | 0.1 | 282 | 1.00 |
| 4-2 | Dye 1 & Dye 2 | Comparison | 0 | 0 | 0.10 | 379 | 1.34 |
| 4-3 | Dye 1 & TBAB/TSS | Comparison | 1.00 | 1.0 | 0.12 | 428 | 1.52 |
| 4-4 | Dye 1 & TBAB/TSS & Dye 2 | Invention | 0.71 | 1.0 | 0.12 | 524 | 1.86 |
| 4-5 | Dye 1 & TBAB/TSS & Dye 2 | Invention | 1 | 1.0 | 0.14 | 575 | 2.03 |
| 4-6 | Dye 1 & TBAB/TSS & Dye 2 | Invention | 1.29 | 1.0 | 0.15 | 583 | 2.07 |

¹Speed numbers were calculated from the reciprocal of the exposure in lux-seconds required to produce a density of 0.10 above Dₘᵢₙ.
²Speed relative to Comparison Film Sample 4-1 wherein the emulsion did not have any reduction sensitization and was spectrally sensitized using only Dye 1.

It can be seen from the results of TABLE IV that the Invention emulsions (Film Samples 4-4, 4-5, and 4-6) that contained Dye 2 and increasing amounts of reduction sensitization with TBAB provided increasing sensitivity compared to the comparative emulsions (Film Samples 4-1, 4-2, or 4-3). The sensitivity of the Invention emulsions (Film Samples 4-4, 4-5, and 4-6) reached a maximum value around 0.08 to 0.10 mmole/mole Ag of TBAB. The fog or minimum density levels of the Invention emulsions (Film Samples 4-4, 4-5, and 4-6) increased with higher amounts of TBAB.

### Invention Example 5

Film coating evaluations were carried out in blue-sensitive color photographic film using a sulfur- and gold-sensitized 3.4 μm×0.14 μm silver iodobromide tabular emulsion containing 4.9 mol % iodide. Eight emulsion melts were prepared. Each emulsion melt (0.07 mole Ag) was heated to 43° C. and sodium thiocyanate (70 mg/Ag mole) was added. After a 5 minute hold, either no reducing agent was added (Film Samples 5-1 and 5-2) or 0.057 (Film Sample 5-4), 0.080 (Film Samples 5-3, 5-5, 5-7, and 5-8), or 0.10 (Film Sample 5-6) μmole/mole Ag of t-butylamine borane (TBAB) was added followed by a 2 minute hold. Then either no oxidizing agent was added (Film Samples 5-1 and 5-2) or either 1.06 (Film Sample 5-7), 1.30 (Film Samples 5-3, 5-4, 5-5, and 5-6), or 1.60 (Film Sample 5-8) μmole/Ag mole potassium 4-methylbenzenethiosulfonate (TSS) was added. After a 2 minute hold, 0.78 mmole/Ag mole sensitizing Dye 1 was added followed by a 10 minute hold. This was followed by either no addition (Film Samples 5-1 and 5-2) or adding a second portion of either 1.06 (Film Sample 5-7), 1.30 (Film Samples 5-3, 5-4, 5-5, and 5-6), or 1.60 (Film Sample 5-8) μmole/Ag mole TSS with a subsequent 2 minute hold. This was followed by the addition of sodium aurous dithiosulfate dehydrate (1.53 mg/Ag mole). After a 2 minute hold, sodium thiosulfate pentahydrate (0.72 mg/Ag mole) was added, followed by a 2 minute hold. Then, 3-(2-methylsulfamoylethyl)-benzothiazolium tetrafluoroborate (35 mg/Ag mole) was added. Following a 2 minute hold, 1-(3-acetamidophenyl)-5-mercaptotetrazole (14 mg/Ag mole) was added with a subsequent 2 minute hold. The emulsion was heated to 63° C. and held for 10 minutes. After cooling to 43° C., 4-hydroxy-6-methyl-1,3,3a,7-tetraazaindene, sodium salt, monohydrate, (2.5 g/Ag mole) was added and then held for 3 minutes. Then, either no Dye 2 (Film Samples 5-1 and 5-3) was added or 0.9 mmole/mole Ag of Dye 2 was added (Film Samples 5-2, 5-4, 5-5, 5-6, 5-7, and 5-8) followed by a 20 minute hold. Each melt was subsequently chilled to 5° C. Before coating, the emulsion melt was combined with gelatin and distilled water; and subsequently heated to 40° C. to mix the components. Single-layer coatings were made on an acetate support to provide a silver lay down of 861 mg/m². Before coating, the silver melt was combined with a coupler dispersion containing two yellow forming couplers, Y-1 and Y-2 at a 1:1 weight ratio for a total lay down of 430.6 mg/m². The gelatin lay down was 2153 mg/m².

A hardened overcoat was applied over the coating emulsion layer at 1200 mg/m². Sensitometric exposures (0.02 second) were carried out using tungsten exposure with filtration through 0.6 Inconel and Wratten 2b filters. The resulting color photographic film elements were processed for 3.25 minutes in the known ECN-2 color process. The results are shown below in TABLE V.

TABLE V

| Film | | | Relative TBAB | Relative TSS | | | Relative |
|---|---|---|---|---|---|---|---|
| Samples | | | Amount Added | Amount Added | Dₘᵢₙ | Speed¹ | Speed² |
| 5-1 | Dye 1 | Comparison | 0 | 0 | 0.1 | 331 | 1.00 |
| 5-2 | Dye 1 & Dye 2 | Comparison | 0 | 0 | 0.11 | 416 | 1.26 |
| 5-3 | Dye 1, TBAB, TSS | Comparison | 1.0 | 1.0 | 0.12 | 463 | 1.40 |
| 5-4 | Dye 1, TBAB, TSS, Dye 2 | Invention | 0.71 | 1.0 | 0.14 | 560 | 1.69 |
| 5-5 | Dye 1, TBAB, TSS, Dye 2 | Invention | 1.0 | 1.0 | 0.14 | 615 | 1.86 |
| 5-6 | Dye 1, TBAB, TSS, Dye 2 | Invention | 1.29 | 1.0 | 0.17 | 658 | 1.99 |
| 5-7 | Dye 1, TBAB, TSS, Dye 2 | Invention | 1.0 | 0.80 | 0.16 | 615 | 1.86 |
| 5-8 | Dye 1, TBAB, TSS, Dye 2 | Invention | 1.0 | 1.20 | 0.13 | 606 | 1.83 |

¹Speed numbers were calculated from the reciprocal of the exposure in lux-seconds required to produce a density of 0.10 above Dₘᵢₙ.
²Speed relative to Comparison Film Sample 5-1 wherein the emulsion did not have any reduction sensitization and was spectrally sensitized using only Dye 1.

It can be seen from the results in TABLE V that the Invention emulsions (Film Samples 5-4, 5-5, and 5-6) that contained Dye 2 and increasing amounts of reduction sensitization with TBAB provided increasing sensitivity compared to the comparative emulsions (Film Samples 5-1, 5-2, and 5-3). The fog or minimum density levels of the Invention emulsions (Film Samples 5-4, 5-5, and 5-6) increased with higher amounts of TBAB. Increasing the amount of TSS resulted in lower fog density for the Invention emulsions (Film Samples 5-5, 5-7, and 5-8). The emulsion (Film Sample 5-8) sensitivity decreased at amounts greater than 1.30 mmole/Ag mole TSS.

### Invention Example 6

Film coating evaluations were carried out in blue-sensitive color photographic film using a sulfur- and gold-sensitized 3.5 μm×0.24 μm silver iodobromide tabular emulsion containing 6.7 mol % iodide. Eleven emulsion melts were prepared. Each emulsion melt (0.07 mole Ag) was heated to 43° C. and sodium thiocyanate (40 mg/Ag mole) was added. After a 5 minute hold, either no reducing agent was added (Film Samples 6-1 and 6-2) or 0.115 (Film Sample 6-4), 0.172 (Film Samples 6-3, 6-5, 6-7, 6-8, 6-9, 6-10, and 6-11), or 0.230 (Film Sample 6-6) μmole/mole Ag of t-butylamine borane (TBAB) was added followed by a 2 minute hold. Then, either no oxidizing agent was added (Film Samples 6-1 and 6-2) or either 0.44 (Film Samples 6-8 and 6-9), 0.66 (Film Samples 6-3, 6-4, 6-5, 6-6, and 6-7), or 0.88 (Film Samples 6-10 and 6-11) μmole/Ag mole potassium 4-methylbenzenethiosulfonate (TSS) was added with a subsequent 2 minute hold. Then, 3-(2-methylsulfamoylethyl)-benzothiazolium tetrafluoroborate (12 mg/Ag mole) was added. Following a 2 minute hold, 0.41 mmole/Ag mole sensitizing Dye 1 was added followed by a 10 minute hold. This was followed by either no addition (Film Samples 6-1 and 6-2) or adding a second portion of either 0.66 (Film Sample 6-7), 0.88 (Film Samples 6-9 and 6-11), 1.33 (Film Samples 6-3, 6-4, 6-5, and 6-6), or 1.77 (Film Samples 6-8 and 6-10) μmole/Ag mole TSS with a subsequent 2 minute hold. This was followed by the addition of sodium aurous dithiosulfate dehydrate (0.54 mg/Ag mole). After a 2 minute hold, sodium thiosulfate pentahydrate (0.25 mg/Ag mole) was added, followed by a 2 minute hold. Each emulsion was heated to 65° C. and held for 10 minutes. After cooling to 43° C., 4-hydroxy-6-methyl-1,3,3a,7-tetraazaindene, sodium salt, monohydrate, (2.5 g/Ag mole) was added and then held for 5 minutes. Then, either no Dye 2 (Film Samples 6-1 and 6-3) was added or 1.0 mmole/mole Ag of Dye 2 was added (Film Samples 6-2, 6-4, 6-5, 6-6, 6-7, 6-8, 6-9, 6-10, and 6-11) followed by a 15 minute hold. Each melt was subsequently chilled to 5° C. Before coating, each emulsion melt was combined with gelatin and distilled water and subsequently heated to 40° C. to mix the components. Single-layer coatings were made on an acetate support to provide a silver lay down was 861 mg/m². Before coating, each silver melt was combined with a coupler dispersion containing two yellow forming couplers, Y-1 and Y-2 at a 1:1 weight ratio for a total lay down of 430.6 mg/m². The gelatin lay down was 2153 mg/m².

A hardened overcoat was applied to the coated emulsion layer at 1200 mg/m². Sensitometric exposures (0.02 second) were carried out using tungsten exposure with filtration through 0.6 Inconel and Wratten 2b filters. The resulting elements were processed for 3.25 minutes in the known ECN-2 color process. The results are shown below in TABLE VI.

TABLE VI

| | | | | Relative 1st | Relative 2nd | | | |
|---|---|---|---|---|---|---|---|---|
| Film | | | Relative TBAB | Portion TSS | Portion TSS | | | Relative |
| Samples | | | Amount Added | Amount Added | Amount Added | Dₘᵢₙ | Speed¹ | Speed² |
| 6-1 | Dye 1 | Comparison | 0 | 0 | 0 | 0.07 | 440 | 1.00 |
| 6-2 | Dye 1 & Dye 2 | Comparison | 0 | 0 | 0 | 0.08 | 497 | 1.13 |
| 6-3 | Dye 1, TBAB, TSS | Comparison | 1.0 | 1.0 | 2.0 | 0.09 | 452 | 1.03 |
| 6-4 | Dye 1, TBAB, TSS, Dye 2 | Invention | 0.67 | 1.0 | 2.0 | 0.08 | 538 | 1.22 |
| 6-5 | Dye 1, TBAB, TSS, Dye 2 | Invention | 1.0 | 1.0 | 2.0 | 0.08 | 552 | 1.25 |
| 6-6 | Dye 1, TBAB, TSS, Dye 2 | Invention | 1.33 | 1.0 | 2.0 | 0.11 | 568 | 1.29 |
| 6-7 | Dye 1, TBAB, TSS, Dye 2 | Invention | 1.0 | 1.0 | 1.0 | 0.10 | 524 | 1.19 |
| 6-8 | Dye 1, TBAB, TSS, Dye 2 | Invention | 1.0 | 0.67 | 2.67 | 0.10 | 524 | 1.19 |
| 6-9 | Dye 1, TBAB, TSS, Dye 2 | Invention | 1.0 | 0.67 | 1.33 | 0.11 | 575 | 1.31 |
| 6-10 | Dye 1, TBAB, TSS, Dye 2 | Invention | 1.0 | 1.33 | 2.67 | 0.09 | 502 | 1.14 |
| 6-11 | Dye 1, TBAB, TSS, Dye 2 | Invention | 1.0 | 1.33 | 1.33 | 0.09 | 552 | 1.25 |

¹Speed numbers were calculated from the reciprocal of the exposure in lux-seconds required to produce a density of 0.10 above Dₘᵢₙ.
²Speed relative to Comparison Film Sample 6-1 wherein the emulsion did not have any reduction sensitization and was spectrally sensitized using only Dye 1.

It can be seen from the results in TABLE VI that the Invention emulsions (Film Samples 6-4, 6-5, and 6-6) that contained Dye 2 and increasing amounts of reduction sensitization with TBAB with the amount TSS added in the first portion and second portion at 0.66 and 1.33 μmole/Ag mole TSS, respectively, provided increasing sensitivity compared to the comparative emulsions (Film Samples 6-1, 6-2, and 6-3). Film Samples 6-5, 6-7, 6-8, 6-9, 6-10, and 6-11 showed that sensitivity and fog of the Invention emulsions depend on the relative ratios (1:1, 1:2, or 1:4) of TSS added in the first and second portions; and on the total amount of TSS added to the emulsion (1.3 to 2.7 μmole/Ag mole TSS). The results in TABLE VI indicate that the best ratio of TSS added in the first portion to that added in the second portion is 1:2.

### Invention Example 7

Multilayer films of this invention were prepared by coating the following layers on a cellulose triacetate support containing a process-removable carbon-black (“Rem-Jet”) layer on the non emulsion side. Coating coverage's are in grams/m², emulsion sizes as determined by the disc centrifuge method are reported in diameter x thickness in μm. Surfactants, coating aids, emulsion addenda (including 4-hydroxy-6-methyl-1,3,3a,7-tetraazaindene) were added to the appropriate layers as is common in the art. Couplers and other non-soluble materials were added either as conventional oil-in-water gel dispersions or as finely milled particulates, as known in the art.

The following compounds were used to prepare these multilayer films:

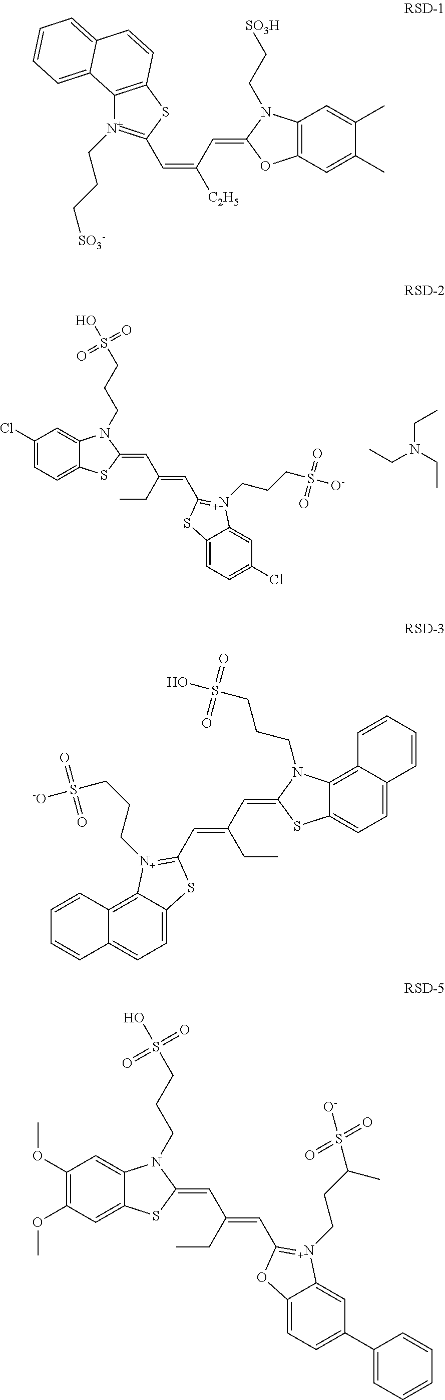

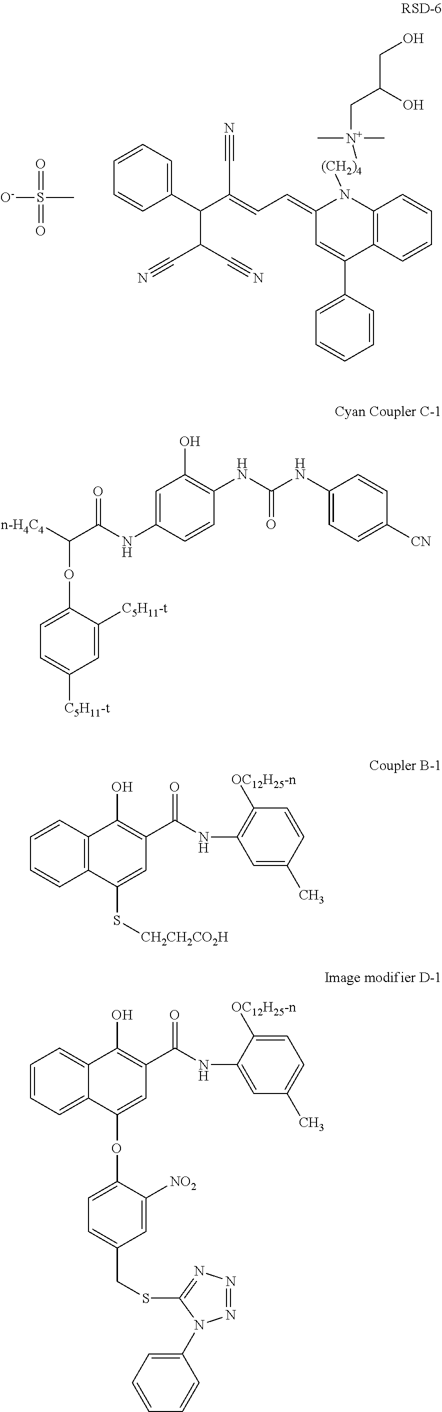

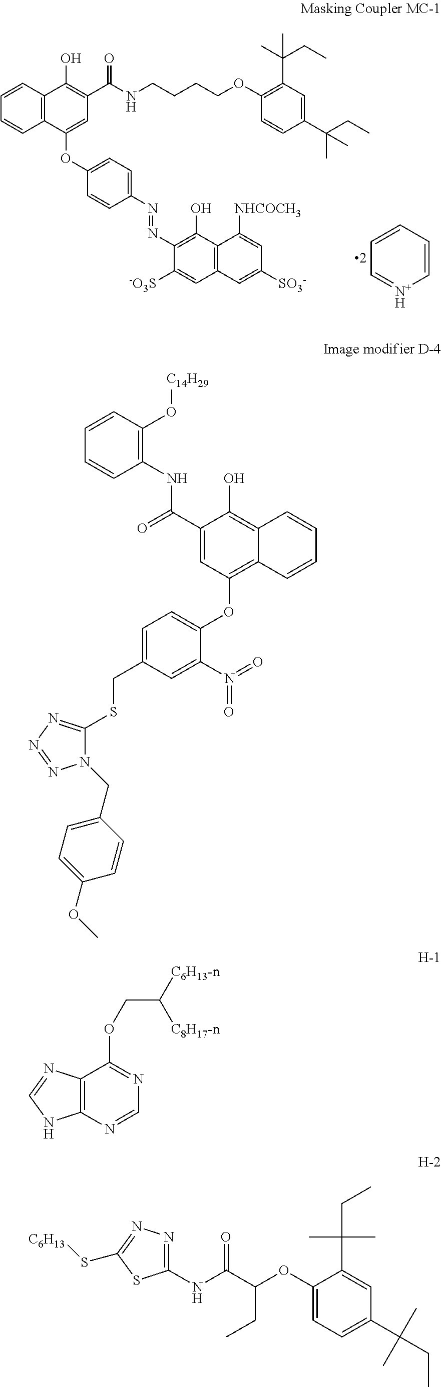

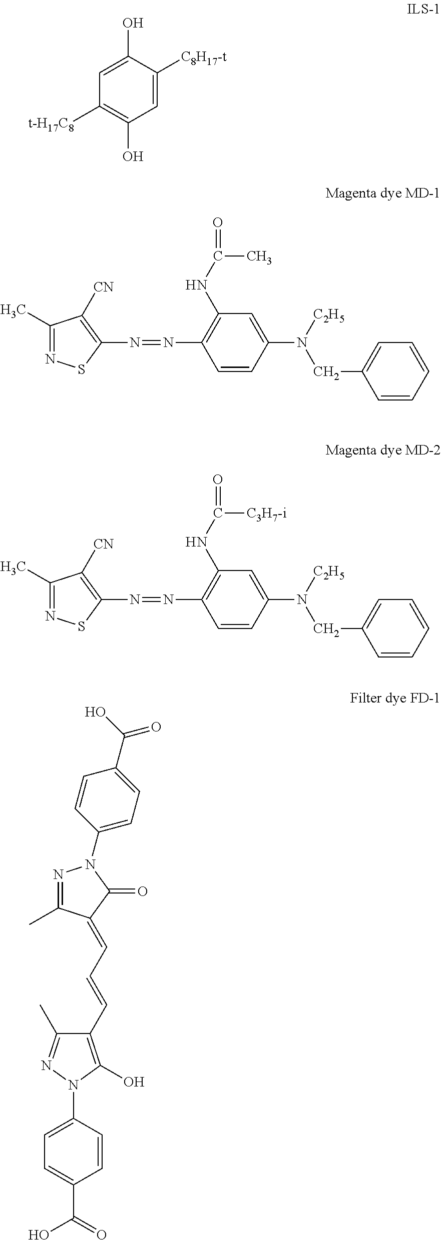

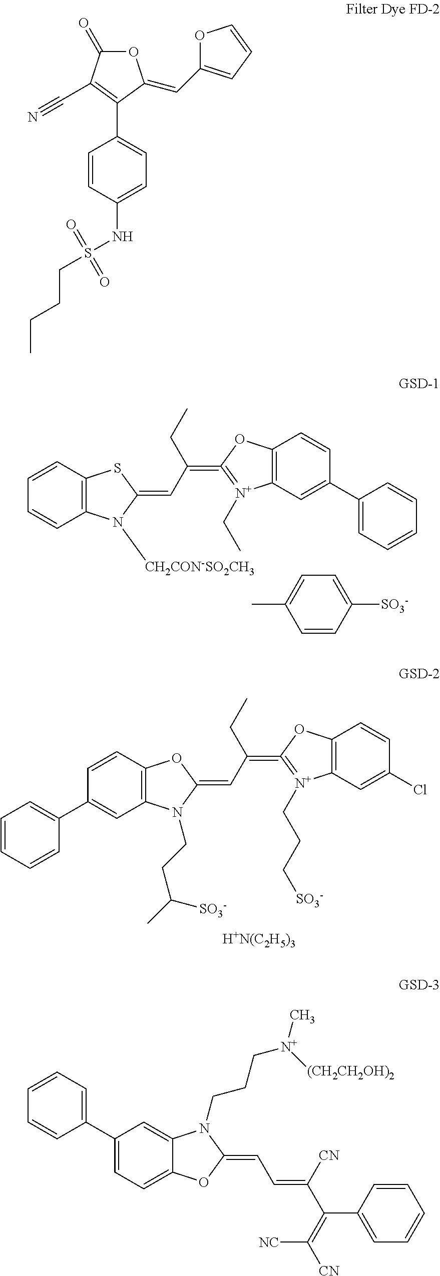

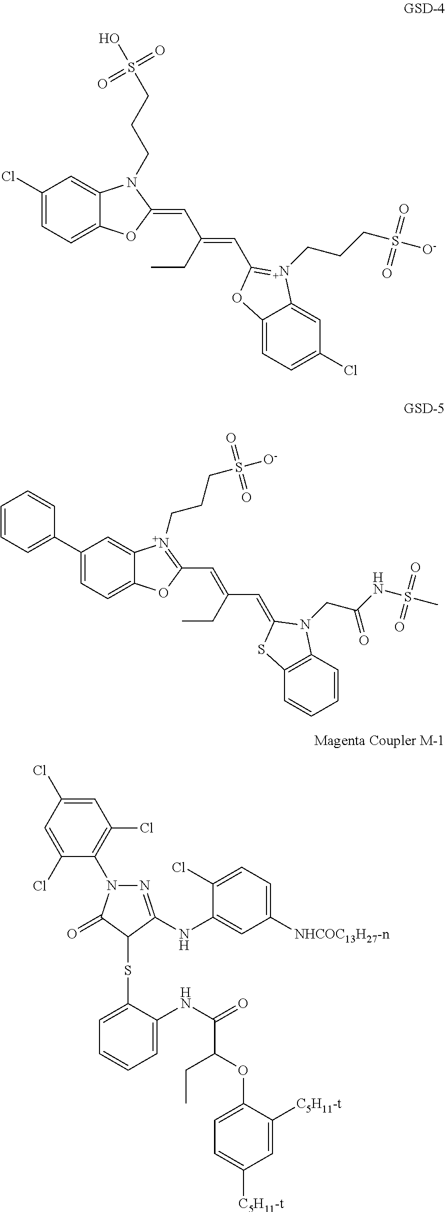

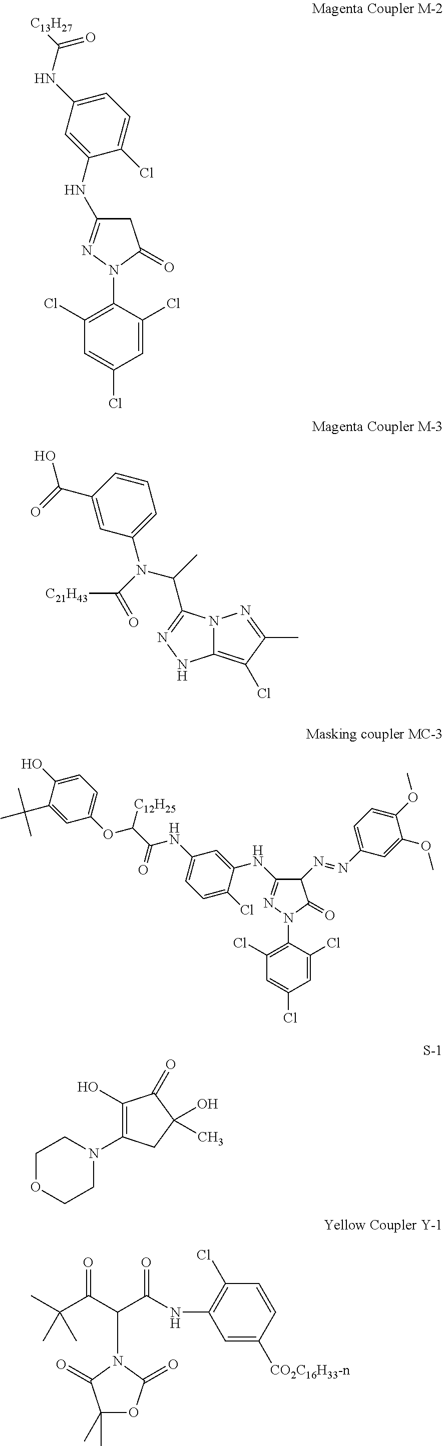

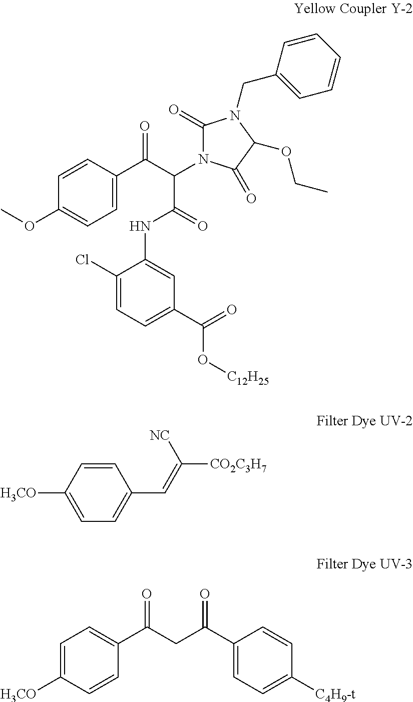

### Multilayer Photographic Film Format

SUPPORT: Cellulose Triacetate film support containing a process removable carbon-black (“Rem-Jet”) layer on the non-emulsion side.
LAYER 1 (Slow Cyan Layer): a blend of two red sensitized tabular iodobromide emulsions: (i) 0.50×0.126 μm, 4.5% iodide (sensitized with a mixture of RSD-2, RSD-4, and RSD-5) at 0.200, (ii) 0.55×0.08 μm, 1.5% iodide (sensitized with a mixture of RSD-2 and RSD-4) at 0.544; cyan dye forming coupler C-1 at 0.376; bleach accelerator releasing coupler B-1 at 0.056; image modifier D-1 at 0.040; masking coupler MC-1 at 0.016; DYE-1 at 0.006; and gelatin at 1.900.
LAYER 2 (Mid Cyan Layer): a blend of two red sensitized tabular iodobromide emulsions: (i) 0.65×0.127 μm, 4.5% iodide (sensitized with a mixture or RSD-2, RSD-4, and RSD-5) at 0.604, (ii) a 0.50×0.126 μm, 4.5% iodide (sensitized with a mixture of RSD-2, RSD-4, and RSD-5) at 0.160; C-1 at 0.088; D-1 at 0.056; D-4 at 0.010; development accelerator H-2 at 0.032; MC-1 at 0.008; and gelatin at 1.300.
LAYER 3 (Fast Cyan Layer): an iodobromide tabular emulsion, 1.22×0.112 μm, 4.5% iodide (sensitized with a mixture of RSD-1, RSD-2, RSD-4, and RSD-6) at 0.510; C-1 at 0.040; B-1 at 0.013; D-1 at 0.008; MC-1 at 0.007; H-2 at 0.032; and gelatin at 1.110.
LAYER 4 (Interlayer): ILS-1 at 0.072; MD-1 at 0.004, MD-2 at 0.004; process removable filter dye FD-1 at 0.040; gelatin at 0.915.
LAYER 5 (Slow Magenta Layer): a blend of three green sensitized iodobromide tabular emulsions; (i) a 0.52×0.125 μm, 3% iodide (sensitized with a mixture of GSD-1, GSD-2, and GSD-3) at 0.200, (ii) 0.33×0.11 μm, 3% iodide (sensitized with a mixture of GSD-1 and GSD-2) at 0.192, and (ii) 0.31×0.121 μm, 3% iodide (sensitized with a mixture of GSD-1 and GSD-2) at 0.248; magenta dye forming couplers M-1 at 0.176, M-2 at 0.192, M-3 at 0.006; masking coupler MC-3 at 0.120; and gelatin at 1.125.
LAYER 6 (Mid Magenta Layer): a blend of two green sensitized iodobromide tabular emulsions; (i) a 0.78×0.106 μm, 4.5% iodide (sensitized with a mixture of GSD-1, GSD-2, and GSD-3) at 0.200, (ii) a 0.57×0.125 μm, 3% iodide (sensitized with a mixture of GSD-3, GSD-4, and GSD-5) at 0.568; M-1 at 0.116; D-7 at 0.008; MC-3 at 0.048; and gelatin at 1.110.
LAYER 7 (Fast Magenta Layer): a green sensitized iodobromide tabular emulsion: 1.40×0.114 μm, 4.5% iodide (sensitized with a mixture of GSD-3, GSD-4 and GSD-5); development accelerator H-1 at 0.020; M-1 at 0.012; M-3 at 0.012; MC-3 at 0.015; D-7 at 0.002; and gelatin at 1.050.
LAYER 8 (Interlayer): ILS-1 at 0.072; filter dye FD-2 at 0.088; addenda S-1 at 0.005; and gelatin at 0.592.
LAYER 9 (Slow Yellow Layer): a blend of three blue sensitized iodobromide tabular emulsions: (i) 1.44×0.134 μm, 4% iodide (sensitized with a mixture of BSD-1 and BSD-3), at 0.256, (ii) 0.75×0.13 μm, 3% iodide (sensitized with a mixture of BSD-1 and BSD-2) at 0.168, and (iii) 0.38×0.12 μm, 3% iodide (sensitized with a mixture of BSD-1 and BSD-2) at 0.256; yellow dye forming coupler Y-1 at 0.920; D-6 at 0.048; and gelatin at 1.800
LAYER 10 (Fast Yellow Layer): a blue sensitized (detailed below) iodobromide tabular emulsion: 2.17×0.142 μm, 6% iodide at 0.512; Y-2 at 0.0.104; H-2 at 0.024; and gelatin at 1.480.
LAYER 11 (UV Protection Layer): Silver Bromide Lippmann emulsion at 0.215; ultraviolet filter dyes UV-2 at 0.112; UV-3 at 0.024; and gelatin at 0.861. Bis(vinylsulfonyl)methane hardener at 1.6% of total gelatin weight in the coating is streamed into this layer during application to the support
LAYER 12 (Protective Overcoat): a blend of permanent and process removable matte beads and gelatin at 0.873.

In this Invention example, the emulsion was sensitized using the combination a novel combination of t-butylamino borane and potassium 4-methylbenzenethiosulfonate in conjunction with traditional sulfur-and-gold chemical sensitization in concert with the spectral sensitizing dyes BSD-1 and BSD-3.

### Comparative Example 1

In the comparative example, the emulsion was chemically and spectrally sensitized (with BSD-1 and BSD-3) followed by post treatment with a combination of 2-(N-propynyl)aminobenzoxazole and aurous sulfide.

Both the Invention Example 7 and Comparative Example 1 were given a neutral stepped exposure, followed by processing in the ECN-2 process. Sensitometric results were measured to provide minimum density, contrast, and speed of the individual red, green, and blue sensitive records. The relevant properties related to these examples and their performances are summarized below in the following TABLE VII.

TABLE VII

| | Reduction | Status M Blue | Blue Speed | Blue Speed |
|---|---|---|---|---|
| | Sensitization | Minimum | at 0.1 | at 0.2 |
| Film Sample | Scheme | Density (Dₘᵢₙ) | above Dₘᵢₙ | above Dₘᵢₙ |
| Comparative | PAB/AuS | 0.793 | 555.1 | 535.9 |
| Example 1 | | | | |
| Invention | TBAB/TSS | 0.795 | 563.5 | 542.6 |
| Example 7 | | | | |

From this data, it is apparent that the use of the present invention in a multicolor photographic element provides superior sensitivity to light (or “speed”) when using the same spectrally sensitized tabular silver halide grains.

The invention has been described in detail with particular reference to certain preferred embodiments thereof, but it will be understood that variations and modifications can be effected within the spirit and scope of the invention.

1. A color silver halide photographic element comprising a support having thereon:
a yellow dye image-forming unit comprising at least one blue-sensitive silver iodobromide emulsion layer having associated therewith at least one yellow dye-forming coupler,
wherein the at least one blue-sensitive silver iodobromide emulsion layer comprises silver iodobromide grains having an aspect ratio of from about 2 to about 40 and comprising at least 1 and up to and including 15 mol % iodide, which silver iodobromide grains have associated therewith at least two blue spectral sensitizing dye layers comprising:
(a) an inner dye layer adjacent the silver iodobromide grains comprising at least one anionic blue spectral sensitizing Dye 1, and
(b) an outer dye layer adjacent to the inner dye layer comprising at least one cationic blue spectral sensitizing Dye 2,
wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,
wherein the silver iodobromide grains also have initially associated therewith an amine borane compound in an amount of from about 0.03 to about 0.5 μmol per mol of silver iodobromide, and
wherein the silver iodobromide grains also have initially associated therewith from about 0.8 to about 4 μmol per mol of silver iodobromide of a thiosulfonate compound having the structure:
R¹—SO₂S-M¹
wherein R¹ represents an aliphatic, carbocyclic, or heterocylic group and M¹ represents a mono-, di-, or tri-valent cation.

2. The photographic element of claim 1 wherein the amine borane compound is a t-butylamine borane.

3. The photographic element of claim 1 wherein the amine borane compound is initially associated with the silver iodobromide grains in an amount of from 0.06 to 0.2 μmol per mol of silver iodobromide.

4. The photographic element of claim 1 wherein Dye 1 is present in an amount of from about 0.4 to about 0.9 mmol per mol of silver iodobromide, and Dye 2 is present in an amount of from about 0.7 to about 1.6 mmol per mol of silver iodobromide.

5. The photographic element of claim 1 wherein Dye 1 has a maximum energy absorption wavelength of from about 450 to about 490 nm, and Dye 2 has a maximum energy absorption wavelength of from about 400 to about 460 nm.

6. The photographic element of claim 1 wherein the thiosulfonate compound is potassium p-toluenethiosulfonate.

7. The photographic element of claim 1 wherein the thiosulfonate compound is initially associated with the silver iodobromide grains in an amount of from about 1 to about 2.5 μmol per mol of silver iodobromide.

8. The photographic element of claim 1 wherein Dye 1 is represented by one of the following Structures (Ia) and (Ib): 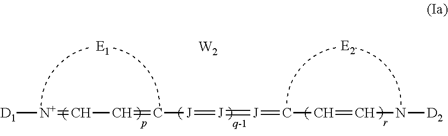
wherein E₁ and E₂ is the same or different and represent the atoms necessary to form a substituted or unsubstituted heterocyclic ring that is a basic nucleus, each J independently represents a substituted or unsubstituted methine group, q is an integer of from 1 to 4, p and r each independently represents 0 or 1, D₁ and D₂ each independently represents substituted or unsubstituted alkyl or aryl groups wherein at least one of D₁ and D₂ contains an anionic substituent and at least one of D₁ and D₂ contains a hydrogen bond accepting substituent, and W₂ is one or more counterions as necessary to balance the charge, 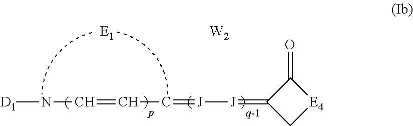
wherein E₁, D₁, J, p, q, and W₂ are as defined above for Structure (Ia), and E₄ represents the atoms necessary to complete a substituted or unsubstituted heterocyclic acidic nucleus that optionally contains a thiocarbonyl group.

9. The photographic element of claim 1 wherein Dye 2 is represented by one of the following Structures (IIa), (IIb), and (IIc): 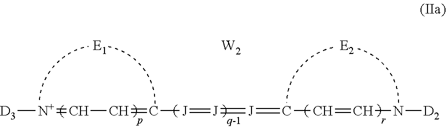
wherein E₁ and E₂ is the same or different and represent the atoms necessary to form a substituted or unsubstituted heterocyclic ring that is a basic nucleus, each J independently represents a substituted or unsubstituted methine group, q is an integer of from 1 to 4, p and r each independently represents 0 or 1, D₃ and D₄ each independently represents substituted or unsubstituted alkyl or aryl groups wherein at least one of E₁, E₂, J, or D₃ and D₄ contains a cationic substituent and at least one of E₁, E₂, J, or D₃ and D₄ contains a hydrogen bond accepting substituent, and W₂ is one or more counterions as necessary to balance the charge, 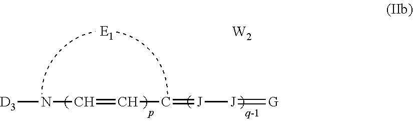
wherein E₁, D₃, J, p, q, and W₂ are as defined above for Structure (IIa), and G represents 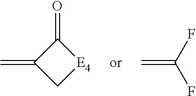
wherein E₄ represents the atoms necessary to complete a substituted or unsubstituted heterocyclic acidic nucleus, F and F′ each independently represents a cyano, ester, acyl, carbamoyl, or alkylsulfonyl group, and at least one of E₁, G, J or D₃ contains a cationic substituent and at least one of E₁, G, J, or D₃ contains a hydrogen bond donating substituent, 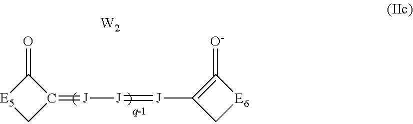
wherein J and W₂ are as defined above for Structure (IIa), q is 2, 3, or 4, E₅ and E₆ independently represent the atoms necessary to complete a substituted or unsubstituted acidic heterocyclic nucleus, and at least one of J, E₅, and E₆ contains a cationic substituent and at least one of J, E₅ and E₆ contains a hydrogen bond donating substituent.

10. The photographic element of claim 1 wherein the at least one blue sensitive silver iodobromide emulsion layer comprises silver iodobromide grains having an aspect ratio of from about 4 to about 30 and an iodide content of from about 2 to about 8 mol %.

11. The photographic element of claim 1 comprising at least two different adjacent blue-sensitive silver iodobromide emulsion layers, the layers independently comprising silver iodobromide grains having an aspect ratio of from about 4 to about 30 and comprising from about 2 to about 8 mol % iodide

12. The photographic element of claim 11 wherein the silver iodobromide grains of each of the adjacent blue-sensitive silver iodobromide emulsion layers is sulfur and gold chemically sensitized, and each adjacent blue-sensitive silver iodobromide emulsion layer contains a Dye 1, a Dye 2, an amine borane compound, and a thiosulfonate compound initially associated with the silver iodobromide grains, and all in the same or different amounts in the layers.

13. The photographic element of claim 11 wherein the adjacent blue-sensitive silver iodobromide emulsion layers comprise silver iodobromide grains having different amounts of silver iodide and aspect ratios, but each adjacent blue-sensitive silver iodobromide emulsion layer contains the same Dye 1, a Dye 2, amine borane compound, and a thiosulfonate compound initially associated with the silver iodobromide grains, and all in the same amounts in each layer.

14. The photographic element of claim 1 wherein the amine borane compound and the thiosulfonate compound initially associated with the silver iodobromide grains are initially present in a molar ratio to each other of from about 0.04:1 to about 0.12:1.

15. A color silver halide photographic element comprising a support having thereon:
a cyan dye image-forming unit comprising at least one red-sensitive silver halide emulsion layer having associated therewith at least one cyan dye-forming coupler,
a magenta dye image-forming unit comprising at least one green-sensitive silver halide emulsion layer having associated therewith at least one magenta dye-forming coupler, and
a yellow dye image-forming unit comprising at least one blue-sensitive silver iodobromide emulsion layer having associated therewith at least one yellow dye-forming coupler,
wherein the at least one blue-sensitive silver iodobromide emulsion layer comprises silver iodobromide grains having an aspect ratio of from about 2 to about 40 and comprising at least 1 and up to and including 15 mol % iodide, which silver iodobromide grains have associated therewith at least two blue spectral sensitizing dye layers comprising:
(a) an inner dye layer adjacent the silver iodobromide grains comprising at least one anionic blue spectral sensitizing Dye 1, and
(b) an outer dye layer adjacent to the inner dye layer comprising at least one cationic blue spectral sensitizing Dye 2,
wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,
wherein the silver iodobromide grains also have initially associated therewith an amine borane compound in an amount of from about 0.03 to about 0.5 μmol per mol of silver iodobromide, and
wherein the silver iodobromide grains also have initially associated therewith from about 0.8 to about 4 μmol per mol of silver iodobromide of a thiosulfonate compound having the structure:
R¹—SO₂S-M¹
wherein R¹ represents an aliphatic, carbocyclic, or heterocylic group and M¹ represents a mono-, di-, or tri-valent cation.

16. The photographic element of claim 15 that is a motion picture originating film.

17. The photographic element of claim 1 further comprising a development promoting agent is close association with the yellow dye image-forming unit.

18. A method of providing a color photographic image comprising color developing the photographic element of claim 1 that has been imagewise exposed using a color developing agent.

19. A method of making the photographic element of claim 1 comprising:
preparing a blue-sensitive silver iodobromide emulsion by mixing silver iodobromide grains having an aspect ratio of from about 2 to about 40 and comprising at least 1 and up to and including 15 mol % iodide, individually with:
(a) an anionic blue spectral sensitizing Dye 1 to provide an inner dye layer adjacent the silver iodobromide grains,
(b) a cationic blue spectral sensitizing Dye 2 to provide an outer dye layer adjacent to the inner dye layer,
wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,
(c) an amine borane compound in an amount of from about 0.03 to about 0.5 μmol per mol of silver iodobromide, and
(d) from about 0.8 to about 4 μmol per mol of silver iodobromide of a thiosulfonate compound having the structure:
R¹—SO₂S-M¹
wherein R¹ represents an aliphatic, carbocyclic, or heterocylic group and M¹ represents a mono-, di-, or tri-valent cation, and
applying the blue-sensitive silver halide emulsion to a support.

20. The method of claim 18 wherein the amine borane compound is mixed with the silver iodobromide grains prior to the mixing of a first portion of the thiosulfonate compound.

21. The method of claim 19 wherein the amine borane compound and thiosulfonate compound are mixed with the silver iodobromide grains prior to the mixing of Dye 1 with the silver iodobromide grains.

22. The method of claim 21 further comprising chemical sensitization of the silver iodobromide grains with sulfur, gold, or both sulfur and gold after a second portion of the thiosulfonate compound is mixed with the silver iodobromide grains that follows the mixing of the Dye 1 with the silver iodobromide grains.

23. The method of claim 19 further comprising chemical sensitization of the silver iodobromide grains with sulfur, gold, or both sulfur and gold, followed by addition of the Dye 2.

24. The method of claim 19 wherein the blue-sensitive silver iodobromide emulsion is prepared using the following sequence of steps:
(a′) mixing the silver iodobromide grains with the amine borane compound,
(b′) mixing the silver iodobromide grains with a first portion of a thiosulfonate compound,
(c′) mixing the silver iodobromide grains with the Dye 1,
(d′) mixing the silver iodobromide grains with a second portion of a thiosulfonate compound,
(e′) chemically sensitizing the silver iodobromide grains with sulfur, gold, or both sulfur and gold,
(f′) treating the silver iodobromide grains by: heating them to a temperature of from about 50 to about 70° C., holding the silver iodobromide grains at the temperature for at least 3 and up to and including 60 minutes, and cooling the silver iodobromide grains to a temperature of from about 35 to about 45° C., and
(g′) mixing the silver iodobromide grains with the Dye 2.

25. The method of claim 24 further comprising adding a benzothiazolium or acetamido-mercaptotetrazole compound, or both types of compounds, to the silver iodobromide grains between steps (e′) and (f′) as an antifoggant.

26. The method of claim 24 comprising further adding a tetraazaindene compound to the silver iodobromide grains between steps (f′) and (g′) in an amount of from about 3 to about 20 mol per mol of silver iodobromide.

27. The method of claim 24 wherein the first and second portions of the thiosulfonate compound are provided in a weight ratio to each other of from about 2:1 to about 1:2.

28. The method of claim 24 wherein the first portion of the thiosulfonate compound is at least as large as or larger than the second portion of the thiosulfonate compound.

29. The method of claim 24 wherein the same thiosulfonate compound is used in the first and second portions.

30. A method of preparing a blue-sensitive silver iodobromide emulsion by mixing silver iodobromide grains having an aspect ratio of from about 2 to about 40 and comprising at least 1 and up to and including 15 mol % iodide, individually with:
(a) an anionic blue spectral sensitizing Dye 1 to provide an inner dye layer adjacent the silver iodobromide grains,
(b) a cationic blue spectral sensitizing Dye 2 to provide an outer dye layer adjacent to the inner dye layer,
wherein Dye 1 and Dye 2 are held together by substantially only a non-covalent force, Dye 2 absorbs light at equal or higher energy than Dye 1, and the maximum energy emission wavelength of Dye 2 overlaps but is not exactly corresponding to the maximum energy absorption wavelength of Dye 1,
(c) an amine borane compound in an amount of from about 0.03 to about 0.5 μmol per mol of silver iodobromide, and
(d) from about 0.8 to about 4 μmol per mol of silver iodobromide of a thiosulfonate compound having the structure:
R¹—SO₂S-M¹
wherein R¹ represents an aliphatic, carbocyclic, or heterocylic group and M¹ represents a mono-, di-, or tri-valent cation,
wherein the blue-sensitive silver iodobromide emulsion is prepared using the following sequence of steps:
(a′) mixing the silver iodobromide grains with the amine borane compound,
(b′) mixing the silver iodobromide grains with a first portion of a thiosulfonate compound,
(c′) mixing the silver iodobromide grains with the Dye 1,
(d′) mixing the silver iodobromide grains with a second portion of a thiosulfonate compound,
(e′) chemically sensitizing the silver iodobromide grains with sulfur, gold, or both sulfur and gold,
(f′) treating the silver iodobromide grains by: heating them to a temperature of from about 50 to about 70° C., holding the silver iodobromide grains at the temperature for at least 3 and up to and including 60 minutes, and cooling the silver iodobromide grains to a temperature of from about 35 to about 45° C., and
(g′) mixing the silver iodobromide grains with the Dye 2.

31. The method of claim 30 wherein the second portion of the thiosulfonate compound is the same amount or less than the first portion of the thiosulfonate compound.
